(19) United States
(12) Patent Application Publication
(10) Pub. No.: US 2007/0206224 A1
(43) Pub. Date: Sep. 6, 2007

(54) Server and method for automatically recognizing on another host computer data recognizable on a host computer

(75) Inventors: Yuichiro Nagashima, Yokohama (JP); Hiroyuki Shobayashi, Yokohama (JP); Takashi Kitayama, Fujisawa (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/407,912

(22) Filed: Apr. 21, 2006

(30) Foreign Application Priority Data
Mar. 3, 2006 (JP) 2006-057290

(51) Int. Cl. G06K 15/00

(52) U.S. Cl. 358/1.16

(57) ABSTRACT

The present invention is constituted to make it possible to automatically perform the processing required to recognize, on another host computer, data recognizable on a host computer. A server 101 requests OS information and file system information managed by a host A and a host A′. If, based on this information, it is determined that, when the OS of host A and host A′ are the same or even different, the file system of host A is supported by host A′, the server 101 disconnects a host A-recognized logical volume VOL-A1 from host A, and connects it to host A′. Conversely, if it is determined that the OS of host A and host A′ differ, and that the host A file system is not supported by host A′, the server 101 prepares a new logical volume Vol-A1′, causes host A to read out the data inside VOL-A1 and to transfer it to host A′, and causes host A′ to write the transferred data to VOL-A1′.

### CROSS-REFERENCE TO PRIOR APPLICATION

This application relates to and claims priority from Japanese Patent Application No. 2006-57290 filed on Mar. 3, 2006, the entire disclosure of which is hereby incorporated herein by reference.

### BACKGROUND OF THE INVENTION

1. Field of the Invention

The present invention relates to computer technology for recognizing, on another host computer, data recognizable on a host computer.

2. Description of the Related Art

For example, the following is disclosed in Japanese Laid-open Patent No. 2005-115438.

A load monitoring part 21 of a distributed file system management server 2 monitors the load state of respective disks 4a through 4m. When the load of a specified disk exceeds a predetermined level, a data control part 23 moves the data stored on this disk to another disk, and updates the directory information of a directory information database 221 by mirroring this data movement. When there is a query for directory information from any client, a directory notification part 22 sends the updated directory information to this client, which updates the cache 321 of the client directory information database.

### SUMMARY OF THE INVENTION

Now then, a computer system, which is capable of communicating with a plurality of host computers, and one or a plurality of storage subsystems, is known. A storage subsystem, for example, is a disk array system comprising a plurality of disk drives (for example, hard disk drives), which are arrayed together. The storage subsystem comprises a plurality of logical volumes, which are established using physical storage resources provided by the plurality of disk drives, and receives an I/O request (a data read command or write command) from a host computer for a logical volume, and, in accordance with this I/O request, can either write data from a host computer to a logical volume, or read out data from a logical volume and send it to a host computer.

Accordingly, there are times when it is desirable to constitute a computer system such as this so that data inside a certain logical volume can be recognized by another host computer, but in this case, it is necessary that consideration be given to an environment (hereinafter, access environment) for recognizing data inside the above-mentioned certain logical volume from a host computer. If this access environment is ignored, it will not be possible for another host computer to recognize that data. The access environment can differ in accordance with a variety of factors, such as, for example, the environment in a host computer (more specifically, the operating system (hereinafter, OS) of a host computer), or the environment in a storage subsystem (more specifically, the information set in a storage subsystem).

Thus, since the access environment can differ in accordance with a variety of factors, a method that can be considered for making recognizable on another host computer data that is recognizable on a host computer is one that is carried out manually based on individual access environment factors. However, as explained hereinabove, the access environment can affect the environment of both a storage subsystem and a host computer, and create the need to carry out prescribed operations for both the storage subsystem and host computer, and these operations can require complex, specialized knowledge.

Consequently, an object of the present invention is to make it possible to automatically perform the processing required to recognize on another host computer data recognizable on a host computer.

Other objects of the present invention will become clear from the following explanation.

A management computer is communicatively connected to a first and a second host computer, and one or more storage subsystems. The respective host computers carry out the input and output of data to and from a connected logical volume. A storage subsystem comprising the one or more storage subsystems has a first logical volume, which is connected to the above-mentioned first host computer, and a controller for controlling the input and output to and from the above-mentioned first logical volume by the above-mentioned first host computer. The above-mentioned management computer comprises a first host information acquisition part for acquiring from the above-mentioned first host computer first host information by requesting the above-mentioned first host computer for the above-mentioned first host information, which denotes a first data processing environment in the above-mentioned first host computer; a second host information acquisition part for acquiring from the above-mentioned second host computer second host information by requesting the above-mentioned second host computer for the above-mentioned second host information, which denotes a second data processing environment in the above-mentioned second host computer; a comparator for comparing the acquired above-mentioned first host information with the acquired above-mentioned second host information; and an environment setting part for automatically carrying out, in response to the above-mentioned results of comparison, environment setting for the above-mentioned second host computer, and either the above-mentioned storage subsystem or the above-mentioned other storage subsystem, in order that data inside the above-mentioned first logical volume is recognizable to the above-mentioned second host computer.

In a first embodiment, at least the controller of the above-mentioned storage subsystem can comprise a storage region. The above-mentioned storage region can store, for each volume group constituting one or more logical volumes corresponding to the respective host computers, a group ID of a volume group, a volume ID of the one or more logical volumes constituting this volume group, and input/output format information denoting the input/output format of the host computer corresponding to this volume group. The above-mentioned controller can be constituted so as not to perform input or output to or from a logical volume constituting a volume group using an input/output format other than the input/output format denoted by the input/output format information associated to this volume group. In a case like this, OS information related to the OS of the above-mentioned second host computer is included in the above-mentioned second host information, and the above-mentioned environment setting part can send a host group creation request for preparing a new host group corresponding to the above-mentioned second host computer to either the above-mentioned storage subsystem or the above-mentioned other storage subsystem, and can send an input/output format information setting request based on OS information in the above-mentioned second host information to the transmission destination of the above-mentioned host group creation request. Accordingly, either the controller of the above-mentioned storage subsystem or the controller of the above-mentioned other storage subsystem can add a new group ID denoting the above-mentioned new host group to the above-mentioned storage region, and can associate the above-mentioned setting-requested input/output format information to this new group ID.

In a second embodiment, each of the above-mentioned one or more storage subsystems in the above-mentioned first embodiment can comprise a plurality of communication ports. The above-mentioned storage region can store a port ID of a communication port in each of the above-mentioned volume groups. The above-mentioned controller can be constituted so as not to allow input/output via a communication port corresponding to a port ID, which is not associated to a volume group, even if there is input/output via an input/output format denoted by input/output format information associated to this volume group. In a case like this, the above-mentioned environment setting part can also send a port ID setting request to the transmission destination of the above-mentioned host group creation request. Accordingly, either the controller of the above-mentioned storage subsystem or the controller of the above-mentioned other storage subsystem can associate the above-mentioned setting-requested port ID to the above-mentioned new group ID.

In a third embodiment, at least the controller of the above-mentioned storage subsystem can comprise a storage region. The above-mentioned storage region can store, in each logical volume, a volume ID of a logical volume, and a host ID of a host computer for which an input/output format to this logical volume is permitted. The above-mentioned controller can be constituted so as not to perform input or output to or from a logical volume in a host computer other than a host computer, which has a host ID associated to the above-mentioned logical volume. In a case like this, a host ID of the above-mentioned second host computer is included in the above-mentioned second host information, and the above-mentioned environment setting part can send a volume ID of a logical volume, which is recognized by the above-mentioned second host computer to either the above-mentioned storage subsystem or the above-mentioned other storage subsystem, and can send a setting request of a host ID in the above-mentioned second host information to the transmission destination of the above-mentioned volume ID. Accordingly, either the controller of the above-mentioned storage subsystem or the controller of the above-mentioned other storage subsystem can associate the above-mentioned setting-requested host ID to a received volume ID in the above-mentioned storage region.

In a fourth embodiment, when, in accordance with the results of the above-mentioned comparison, the above-mentioned first data processing environment is supported by the above-mentioned second host computer, the above-mentioned environment setting part can send to the above-mentioned first host computer a disconnection request for disconnecting the above-mentioned first logical volume of inside the above-mentioned storage subsystem, and can send to the above-mentioned second host computer a connection request for connecting to the above-mentioned first logical volume. Accordingly, it becomes possible for the above-mentioned first logical volume to be disconnected from the above-mentioned first host computer, and for the above-mentioned first logical volume to be connected to the above-mentioned second host computer.

In a fifth embodiment, first OS type information, which denotes the type of the first OS of the above-mentioned first host computer, can be included in the above-mentioned first host information of the above-mentioned fourth embodiment. Second OS type information, which denotes the type of the second OS of the above-mentioned second host computer, can be included in the above-mentioned second host information. When the above-mentioned first data processing environment is supported by the above-mentioned second host computer, the second OS type denoted by the above-mentioned second OS type information can be deemed compatible with the first OS type denoted by the above-mentioned first OS type information.

In a sixth embodiment, first volume format information, which denotes a first volume format supported by the above-mentioned first OS, can also be included in the above-mentioned first host information of the above-mentioned fifth embodiment. Second volume format information, which denotes a second volume format supported by the above-mentioned second OS, can also be included in the above-mentioned second host information. If the second volume format denoted by the above-mentioned second volume format information supports the first volume format denoted by the above-mentioned first volume format information, even if the second OS type denoted by the above-mentioned second OS type information is not compatible with the first OS type denoted by the above-mentioned first OS type information, the above-mentioned first data processing environment can still be supported by the above-mentioned second host computer.

In a seventh embodiment, the above-mentioned volume format in the above-mentioned sixth embodiment can be a file system and/or a volume manager supported by the OS.

In an eighth embodiment, at least the controller of the above-mentioned storage subsystem in the fourth embodiment can comprise a storage region. The above-mentioned storage region can store, for each volume group constituting one or more logical volumes corresponding to the respective host computers, a group ID of a volume group, a volume ID of the one or more logical volumes constituting this volume group, and input/output format information denoting the input/output format of the host computer corresponding to this volume group. The above-mentioned controller can be constituted so as not to perform input or output to or from a logical volume constituting the volume group using an input/output format other than the input/output format denoted by the input/output format information associated to this volume group. OS information related to the OS of the above-mentioned second host computer can be included in the above-mentioned second host information. The above-mentioned environment setting part can send a host group creation request for preparing a new host group corresponding to the above-mentioned second host computer to the above-mentioned storage subsystem, can send an input/output format information setting request based on OS information in the above-mentioned second host information to this storage subsystem, and can send the volume ID of the above-mentioned first logical volume to this storage subsystem. Accordingly, the controller of the above-mentioned storage subsystem can add a new group ID denoting the above-mentioned new host group to the above-mentioned storage region, and can associate to this new group ID the above-mentioned setting-requested input/output format information and the volume ID of the above-mentioned first logical volume.

In a ninth embodiment, when, in accordance with the results of the above-mentioned comparison, the above-mentioned first data processing environment is supported by the above-mentioned second host computer, the above-mentioned environment setting part can cause either the above-mentioned storage subsystem or another storage subsystem to prepare a new second logical volume, and to write data inside the above-mentioned first logical volume to the above-mentioned second logical volume without going through at least the above-mentioned second host computer, and can send to the above-mentioned second host computer a connection request for connecting the above-mentioned second logical volume. Accordingly, it becomes possible for the above-mentioned second logical volume, to which the data inside the above-mentioned first logical volume has been written, to be connected to the above-mentioned second host computer.

In a tenth embodiment, at least the controller of the above-mentioned storage subsystem in the ninth embodiment can comprise a storage region. The above-mentioned storage region can store, in each volume group constituting one or more logical volumes corresponding to the respective host computers, a group ID of a volume group, a volume ID of the one or more logical volumes constituting this volume group, and input/output format information denoting the input/output format of the host computer corresponding to this volume group. The above-mentioned controller can be constituted so as not to perform input or output to or from a logical volume constituting the volume group using an input/output format other than the input/output format denoted by the input/output format information associated to this volume group. In this case, OS information related to the OS of the above-mentioned second host computer can be included in the above-mentioned second host information. The above-mentioned environment setting part can send a host group creation request for preparing a new host group corresponding to the above-mentioned second host computer to either the above-mentioned storage subsystem or the above-mentioned other storage subsystem, can send an input/output format information setting request based on OS information in the above-mentioned second host information to the transmission destination of the above-mentioned host group creation request, and can send the volume ID of the above-mentioned second logical volume to the transmission destination of the above-mentioned host group creation request. Accordingly, either the controller of the above-mentioned storage subsystem or the controller of the above-mentioned other storage subsystem can add a new group ID denoting the above-mentioned new host group to the above-mentioned storage region, and can associate to this new group ID the above-mentioned setting-requested input/output format information and the volume ID of the above-mentioned second logical volume.

In an eleventh embodiment, when, in accordance with the results of the above-mentioned comparison, the above-mentioned first data processing environment is not supported by the above-mentioned second host computer, the above-mentioned environment setting part can cause either the above-mentioned storage subsystem or another storage subsystem to prepare a new second logical volume, and to connect the above-mentioned prepared second logical volume to the above-mentioned second host computer, can cause the above-mentioned second host computer to create a file system for recognizing a data file written to the above-mentioned second logical volume, and can cause the above-mentioned first host computer to read out all data inside the above-mentioned first logical volume and transfer it to the above-mentioned second host computer. Accordingly, when the above-mentioned second host computer writes the above-mentioned transferred data to the above-mentioned second logical volume, and the above-mentioned created file system is updated in accordance therewith, and all data inside the above-mentioned first logical volume is written to the above-mentioned second logical volume, it becomes possible for the data inside the above-mentioned second logical volume to be recognized using the above-mentioned updated file system.

In a twelfth embodiment, when, in accordance with the results of the above-mentioned comparison, the above-mentioned first data processing environment is supported by the above-mentioned second host computer in the above-mentioned eleventh embodiment, the above-mentioned environment setting part can send to the above-mentioned first host computer a disconnection request for disconnecting the above-mentioned first logical volume of inside the above-mentioned storage subsystem, and can send to the above-mentioned second host computer a connection request for connecting to the above-mentioned first logical volume. Accordingly, it becomes possible for the above-mentioned first logical volume to be connected to the above-mentioned second host computer.

In a thirteenth embodiment, when, in accordance with the results of the above-mentioned comparison, the above-mentioned first data processing environment is supported by the above-mentioned second host computer in the above-mentioned twelfth embodiment, the above-mentioned environment setting part can cause either the above-mentioned storage subsystem or another storage subsystem to prepare a new second logical volume, and to write data inside the above-mentioned first logical volume to the above-mentioned second logical volume without going through at least the above-mentioned second host computer, and can send to the above-mentioned second host computer a connection request for connecting to the above-mentioned second logical volume. Accordingly, it becomes possible for the above-mentioned second logical volume, to which the data inside the above-mentioned first logical volume has been written, to be connected to the above-mentioned second host computer.

In a fourteenth embodiment, at least the controller of the above-mentioned storage subsystem in the above-mentioned eleventh embodiment can comprise a storage region. The above-mentioned storage region can store, in each volume group constituting one or more logical volumes corresponding to the respective host computers, a group ID of a volume group, a volume ID of one or more logical volumes constituting this volume group, and input/output format information denoting the input/output format of the host computer corresponding to this volume group. The above-mentioned controller can be constituted so as not to perform input or output to or from a logical volume constituting the volume group using an input/output format other than the input/output format denoted by the input/output format information associated to this volume group. In this case, OS information related to the OS of the above-mentioned second host computer can be included in the above-mentioned second host information. The above-mentioned environment setting part can send a host group creation request for preparing a new host group corresponding to the above-mentioned second host computer to either the above-mentioned storage subsystem or the above-mentioned other storage subsystem, can send an input/output format information setting request based on OS information in the above-mentioned second host information to the transmission destination of the above-mentioned host group creation request, and can send the volume ID of the above-mentioned second logical volume to the transmission destination of the above-mentioned host group creation request. Accordingly, either the controller of the above-mentioned storage subsystem or the controller of the above-mentioned other storage subsystem can add a new group ID denoting the above-mentioned new host group to the above-mentioned storage region, and can associate to this new group ID the above-mentioned setting-requested input/output format information and the volume ID of the above-mentioned second logical volume.

The respective parts comprising the management computer can also be referred to as means. Each part can be realized in accordance with hardware (for example, circuitry), a computer program, or a combination thereof (for example, one or a plurality of CPUs for reading and executing a computer program). Each computer program can be read from a storage resource (for example, a memory) provided in a computer machine. Each computer program can either be installed in this storage resource via a recording medium such as a CD-ROM or DVD (Digital Versatile Disk), or downloaded via a communications network like the Internet or a LAN.

According to the present invention, it becomes possible to automatically carry out the processing required for recognizing on another host computer data recognizable on a host computer.

### BRIEF DESCRIPTION OF THE DRAWINGS

FIG. 1 shows an example of a computer system related to a first embodiment of the present invention;

FIG. 2 shows an overview of the flow of replacement processing from host A to host A′;

FIG. 3 is a schematic diagram of Step S40 of FIG. 2 when the OS types are the same;

FIG. 4 is a schematic diagram of Step S40 of FIG. 2 when the OS types differ, but the host A file system is supported by host A′;

FIG. 5 is a schematic diagram of Step S50 of FIG. 2;

FIG. 6A shows an example of the constitution of a host computer, and FIG. 6B shows an example of the constitution of a storage management server;

FIG. 7 shows an example of the constitution of a storage subsystem;

FIG. 8A shows an example of the constitution of an LU management table inside a storage management server, FIG. 8B shows an example of the constitution of a host group management table inside a storage management server, and FIG. 8C shows an example of the constitution of a host management table inside a storage management server;

FIG. 9A shows an example of the constitution of an LU management table inside a storage subsystem, and FIG. 9B shows an example of the constitution of a host group management table inside a storage subsystem;

FIG. 10 shows an overview of the flows of S10, S20, S30 and S40 of FIG. 2;

FIG. 11 shows an overview of the flows of S10, S20, S30 and S50 of FIG. 2;

FIG. 12 shows an overview of the overall processing flow carried out by a storage management server;

FIG. 13 shows the flow of processing performed by a storage management server in the processing of case 1;

FIG. 14 shows the flow of processing performed by a storage management server in the processing of case 2;

FIG. 15 shows the agent processing flow carried out in S100 of FIG. 10 and FIG. 11;

FIG. 16A shows the agent processing flow carried out in S200 of FIG. 11, and FIG. 16B shows the agent processing flow carried out in S300 of FIG. 10;

FIG. 17A shows the agent processing flow carried out in S400 of FIG. 10, and FIG. 17B shows the agent processing flow carried out in S500 of FIG. 11;

FIG. 18 shows the agent processing flow carried out in S600 of FIG. 11;

FIG. 19A shows the storage subsystem processing flow carried out in S(A) of FIG. 11, and FIG. 19B shows the storage subsystem processing flow carried out in S(B) of FIG. 10 and FIG. 11;

FIG. 20 shows the storage subsystem processing flow carried out in S(C) of FIG. 10 and FIG. 11; and

FIG. 21 shows a variation of the processing carried out in case 2.

### DESCRIPTION OF THE PREFERRED EMBODIMENTS

A first embodiment of the present invention will be explained hereinbelow by referring to the figures.

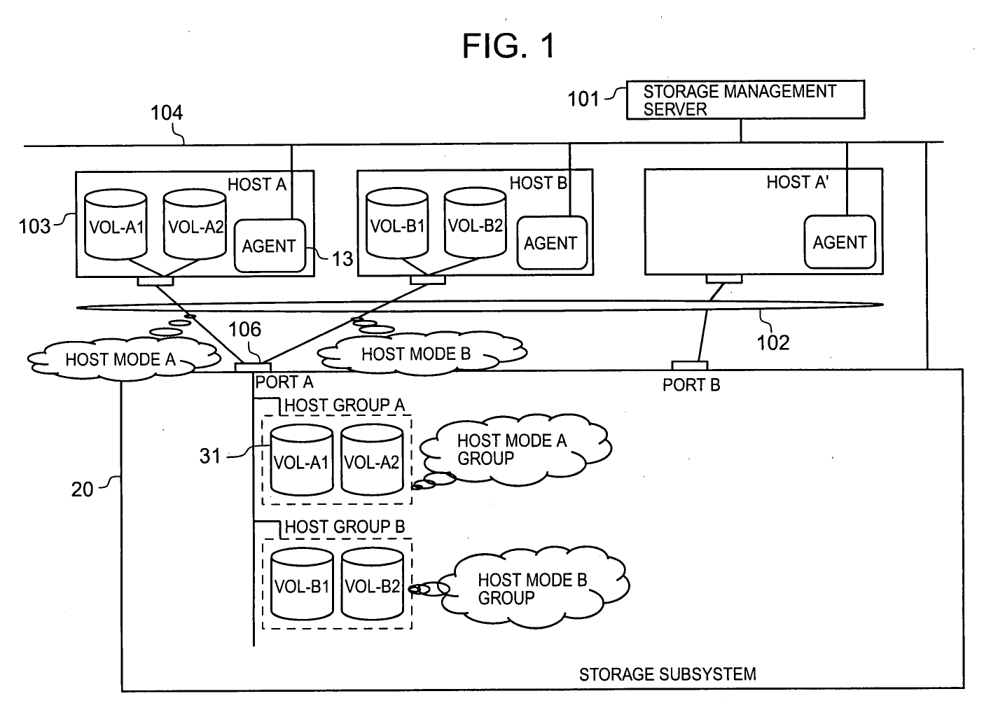

FIG. 1 shows an example of a computer system related to a first embodiment of the present invention.

A storage management server 101, a plurality of host computers 103, and a storage subsystem 20 are connected to a first communications network 104. A plurality of host computers 103, and a storage subsystem 20 are connected to a second communications network 102. Various kinds of networks (for example, a LAN (Local Area Network)) can be employed as the first communications network 104. Various kinds of networks (for example, a SAN (Storage Area Network)) can also be employed as the second communications network 102. Further, the first and second communications networks 104, 102 can also be a single communications network.

The storage subsystem 20 comprises a plurality of communication ports 106, which are connected to the second communications network 102, and a plurality of logical volumes 31. A logical volume 31 is a logical storage device recognized by a host computer 103, and receives an I/O request from a host computer 103 for a logical volume 31. If a received I/O request is a write command, the storage subsystem 20 writes data from the host computer 103 to the logical volume 31 specified in that write command. If a received I/O request is a read command, the storage subsystem 20 reads data from the logical volume 31 specified in that read command and sends it to the host computer 103.

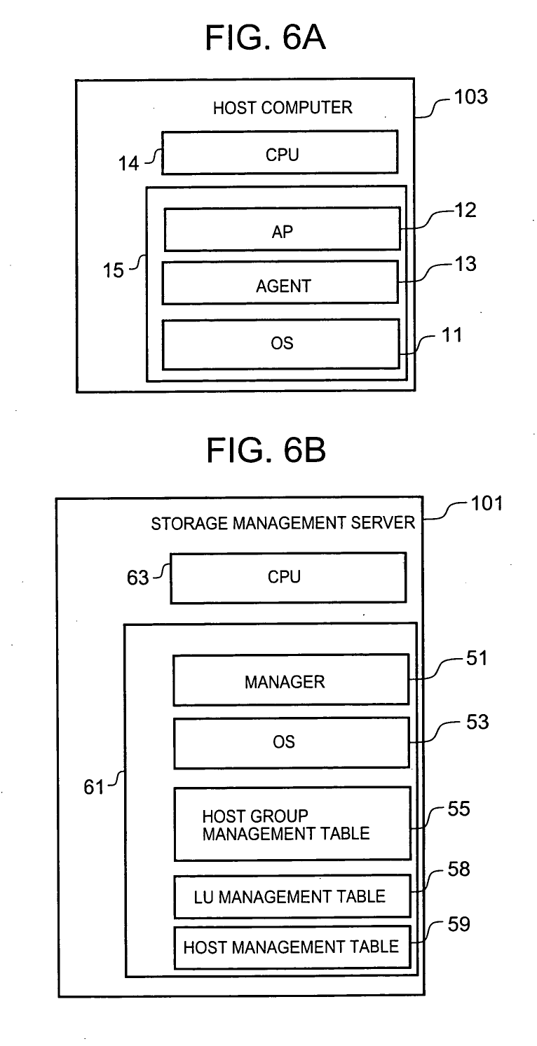

Each host computer 103, for example, comprises a CPU 14 and a storage resource (for example, a memory or hard disk) 15 as shown in FIG. 6A. An OS 11, and a computer program that runs on the OS 11 are stored in the storage resource 15. This computer program, for example, is an agent program (hereinafter, agent) 13, which receives instructions from the storage management server 101, or an application program (hereinafter, AP) 12. A host computer 103 can recognize one or more specified logical volumes 31 from among the plurality of logical volumes 31 that reside in the storage subsystem 20. A host computer 103 can send an I/O request for a recognized logical volume 31 to the storage subsystem 20.

There are cases when the type of OS 11 will differ in accordance with a host computer 103. For example, the OS 11 of a certain host computer 103 is Windows™, but the OS 11 of another host computer 103 is Solaris™ or the like. In a certain type of OS 11, a plurality of file systems are supported. Further, the supported volume format, specifically, the file system or volume manager will differ in accordance with the different types of OS 11.

With this point in mind, the storage subsystem 20 has an access control function for a logical volume 31. In this embodiment, two types of functions serve as an access control function.

A first access control function is a host mode function. Here, “host mode” is an I/O format (in other words, an input/output format), which will differ in accordance with the type of OS. The storage subsystem 20 can associate a host mode to one or more logical volumes that a host computer 103 is allowed to recognize. Hereinbelow, one or more logical volumes associated to a host mode will be called a “host group”. The host mode function is a function, which, when an I/O request for a logical volume inside a host group is received in an associated host mode, carries out the I/O relative to that logical volume, but when an I/O request for a logical volume inside a host group is received in a non-associated host mode, does not carry out the I/O relative to that logical volume. Furthermore, a plurality of host groups in a storage subsystem 20 can be associated to a single port 106 (for example, two host groups A, B can be associated to port A).

A second access control function is a LUN security function. LUN is the abbreviation for logical unit number, and the identifier of a logical unit. In the storage subsystem 20, the WWN (world wide name) of a host computer 103 can be associated to individual logical volumes 31. The WWN of a host computer 103 will be called “host WWN” below. One host WWN, for example, is set for one host bus adapter, and thus, if there is a plurality of host bus adapters in a single host computer 103, the one host computer 103 will have a plurality of host WWNs. A LUN security function is a function, which discloses a logical volume to a host, which has an associated host WWN (for example, it notifies the existence of this logical volume by responding to a query), but does not disclose this logical volume to a host that has a non-associated host WWN.

To make the present invention easier to understand, hereinbelow it is supposed that the plurality of host computers 103 is host A, host B, and host A′ as shown in FIG. 1. Further, it is supposed that the host mode, which is dependent on the OS type of host A, is “host mode A”, that logical volumes VOL-A1 and VOL-A2, which are allocated to host A, are “host group A”, that host mode A is associated to host group A, and that VOL-A1 and VOL-A2 are recognized by host A. Similarly, it is supposed that the host mode, which is dependent on the OS type of host B, is “host mode B”, that logical volumes VOL-B1 and VOL-B2, which are allocated to host B, are “host group B”, that host mode B is associated to host group B, and that VOL-B1 and VOL-B2 are recognized by host B. Conversely, it is supposed that a recognized logical volume 31 does not exist in host A′ (Accordingly, unlike hosts A and B, it is a state wherein a path does not extend between host A′ and storage subsystem 20.).

In a state such as this, for example, when the storage management server 101 receives a host A-to-host A′ replacement instruction (for example, an instruction comprising the host A identifier and the host A′ identifier) from an administrator, who, for example, is referencing a GUI (Graphical User Interface), thereafter a setting can be made such that host A′ is able to recognize the data inside host group A automatically, in other words, without the administrator having to perform any operations manually.

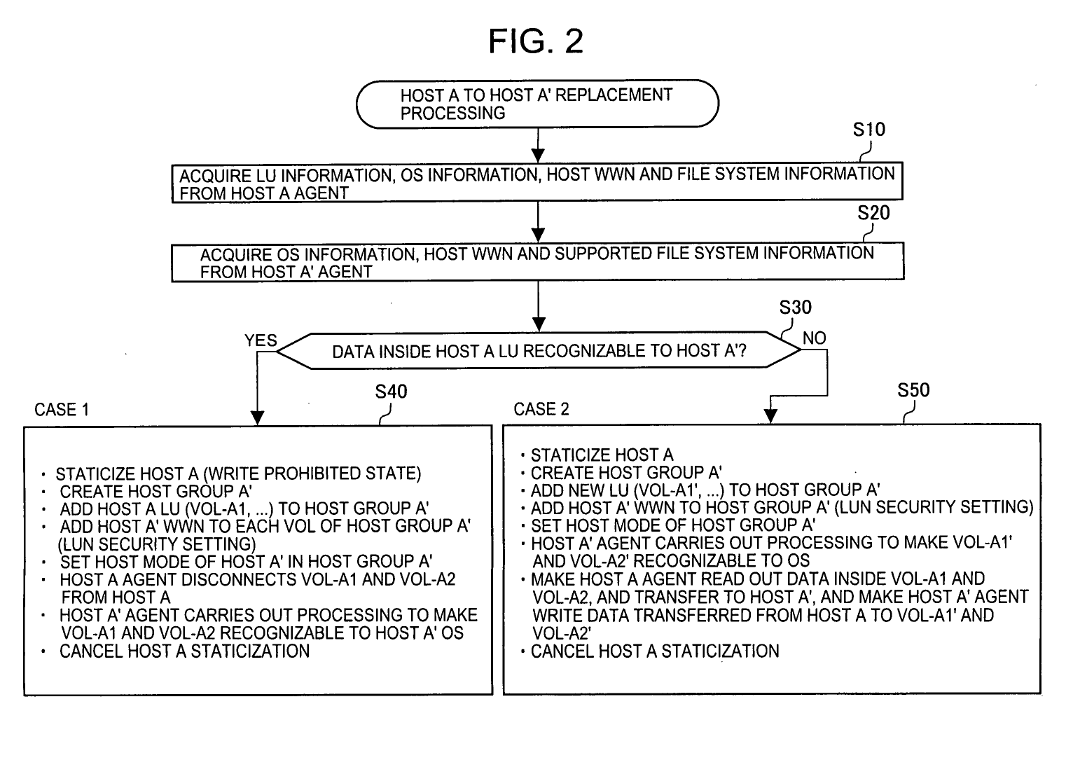

FIG. 2 shows an overview of the flow of replacement processing from host A to host A′.

The storage management server 101 acquires from the host A agent LU information (information related to a logical volume recognized by host A), OS information (information related to the OS of host A), host WWN (the WWN of host A), and file system information (information related to the file system utilized by the host A OS) (Step S10).

Further, the storage management server 101 acquires from the host A′ agent OS information (information related to the OS of host A), host WWN (the WWN of host A′), and supported file system information (information related to the file system supported by the host A′ OS) (Step S20).

The storage management server 101 makes a determination as to whether or not host A′ is able to recognize the data inside a host A-recognized LU (logical volume) (S30). At this point, when it is determined that the OS type of host A and host A′ is the same, or, when it is determined that even though their OS types are different, the file system used by host A is supported by the OS of host A′, the data is determined to be recognizable (S30: YES), and when this is not the case, that is, when it is determined that the OS types differ, and the file system used by host A is not supported by the OS of host A′, the data is determined to be unrecognizable (S30: NO).

When S30 is YES, case 1 processing is executed (S40). That is, the storage management server 101 staticizes host A. Next, the storage management server 101 creates host group A′ in the storage subsystem 20, adds VOL-A1 and VOL-A2 to this host group A′, associates the host WWN of host A′ to each of VOL-A1 and VOL-A2, and associates host mode A′ of host A′ to host group A′. Further, the storage management server 101 causes the host A agent to remove VOL-A1 and VOL-A2 (for example, makes it delete the LUN of VOL-A1 and VOL-A2 stored in host A), and causes the host A′ agent to make VOL-A1 and VOL-A2 recognizable to the host A′ OS (for example, makes it store the LUN of VOL-A1 and VOL-A2). The storage management server 101 cancels the staticization of host A. Furthermore, in the present invention, the staticization of host A refers to a state, wherein a write command is not issued to a logical volume (in this embodiment, VOL-A1 and VOL-A2) that host A recognizes, and staticizing host A, more specifically, for example, means giving an instruction such that a write command is not issued. Conversely, the cancellation of host A staticization refers to returning to the state, wherein a write command can be issued to a logical volume recognized by host A, and canceling host A staticization, more specifically, for example, means giving an instruction such that a write command can be issued.

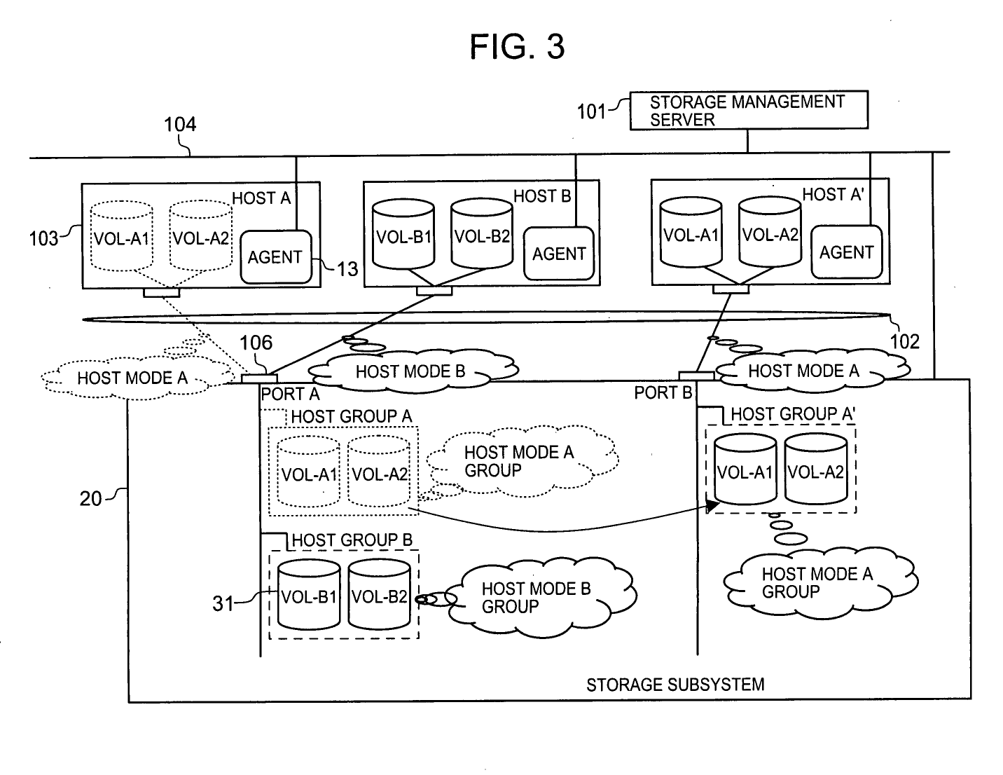

When the OS type is the same, in other words, when the host mode is the same, a process such as that of FIG. 3 is carried out for case 1 processing. That is, as indicated by the dotted line, VOL-A1 and VOL-A2 become unrecognizable to host A, and, consequently, it becomes a state in which VOL-A1 and VOL-A2 cannot be accessed from host A. VOL-A1 and VOL-A2 convert to elements, which constitute host group A′, and, since the OS type of host A and host A′ is the same, the same host mode A as that of host A can be associated to host group A′. In addition, VOL-A1 and VOL-A2 are recognized by host A1. This makes it possible for host A′ to recognize the data inside VOL-A1 or VOL-A2, which had been recognized by host A.

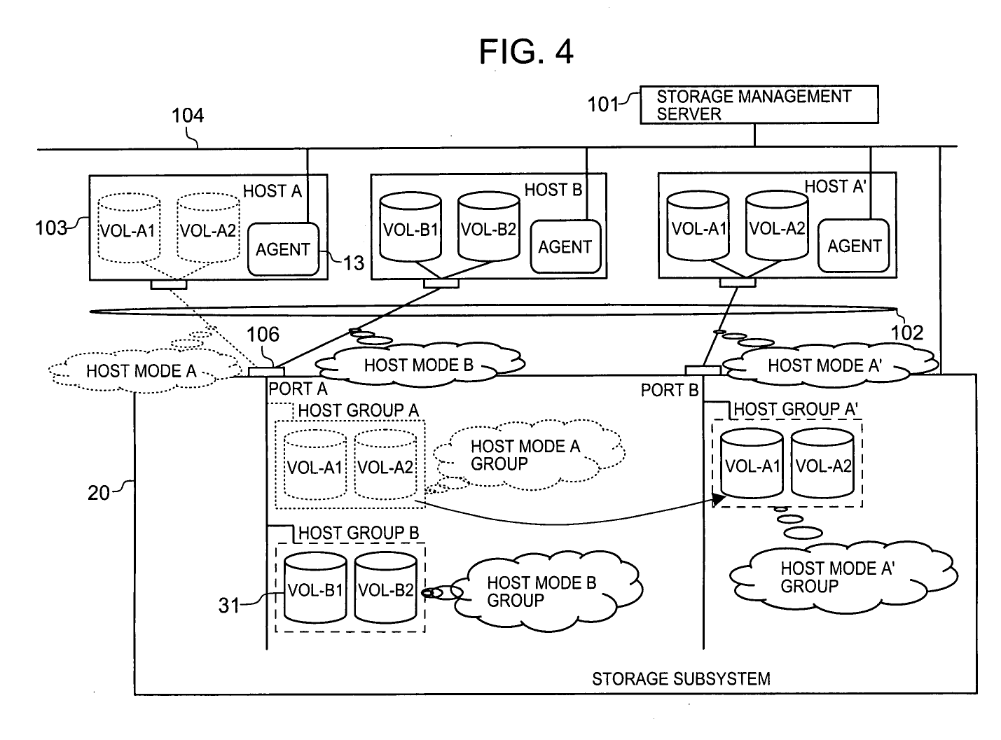

When the OS types differ, but the file system in host A is supported by host A′, a process such as that of FIG. 4 is carried out in case 1 processing. That is, as indicated by the dotted line, VOL-A1 and VOL-A2 become unrecognizable to host A, and, consequently, it becomes a state in which VOL-A1 and VOL-A2 cannot be accessed from host A. VOL-A1 and VOL-A2 convert to elements, which constitute host group A′, and, since the OS types of host A and host A′ differ, host mode A′, which differs from that of host A, is associated to host group A′. In addition, VOL-A1 and VOL-A2 are recognized by host A′. This makes it possible for host A′ to recognize the data inside VOL-A1 or VOL-A2, which had been recognized by host A.

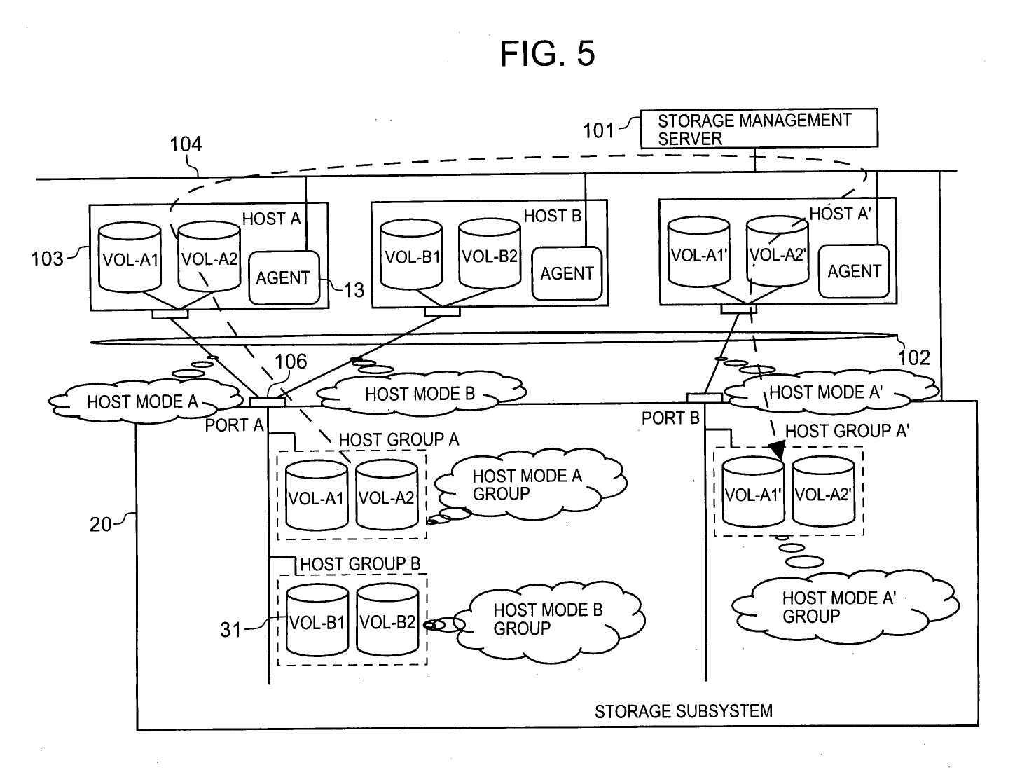

Referring once again to FIG. 2, when S30 is NO, case 2 processing is executed (S50). This will be explained by referring to FIG. 5. That is, the storage management server 101 staticizes host A. Next, the storage management server 101 creates host group A′ in the storage subsystem 20, adds a new VOL-A1′ and VOL-A2′, which differ from VOL-A1 and VOL-A2 (specifically, logic volume having LUN different from VOL-A1 and VOL-A2), to this host group A′, associates the host WWN of host A′ to each of VOL-A1′ and VOL-A2′, and associates host mode A′ of host A′ to host group A′. Further, the storage management server 101 causes the host A′ agent to make VOL-A1′ and VOL-A2′ recognizable to the host A′ OS. In addition, the storage management server 101 causes the host A agent to read out the data inside VOL-A1 and VOL-A2, and transfer it to host A′, and causes the host A′ agent to write the data transferred from host A to VOL-A1′ and VOL-A2′. Then the storage management server 101 cancels the staticization of host A. Thus, thereafter, host A′ becomes capable of recognizing the same data as the data inside VOL-A1 and VOL-A2, which had been recognized by host A, from VOL-A1′ and VOL-A2′, which differ from VOL-A1 and VOL-A2, which had been recognized by host A.

As is clear from the above explanation, in this embodiment, when host A recognizable data is recognizable to another host′, and host A′ is capable of recognizing this data as-is, logical volume-replacement processing is carried out from host A to host A′ as in case 1, and when this data cannot be recognized as-is, processing in which host A′ writes data read out by host A to a logical volume is carried out as in case 2. In case 2, since host A′ itself writes data, which had been recognized by host A, to a logical volume that it recognizes on its own, host A-recognized data becomes recognizable on host A′.

According to this embodiment, it is possible to automatically carry out processing required for allowing another host computer to recognize data recognizable on a host computer, whether or not the host mode (in other words, the OS type) of a host computer is the same as the host mode of another host computer, and whether or not the volume format (for example, the file system or volume manager) supported by a host computer is supported by another host computer.

This embodiment will be explained in detail hereinbelow.

FIG. 6B shows an example of the constitution of a storage management server 101.

The storage management server 101 is a kind of computer, and comprises a CPU 63, and a storage resource (for example, a memory or hard disk) 61. An OS 53, a computer program, which runs on the OS 53, and control information, which is referenced by this computer program, are stored in the storage resource 61. This computer program, for example, has a manager program (hereinafter, manager) 51, which issues an instruction to an agent 13 of each host computer 103. Further, as control information, for example, there are a host group management table 55, a LU management table 58, and a host management table 59. The configuration of each table will be explained in detail below.

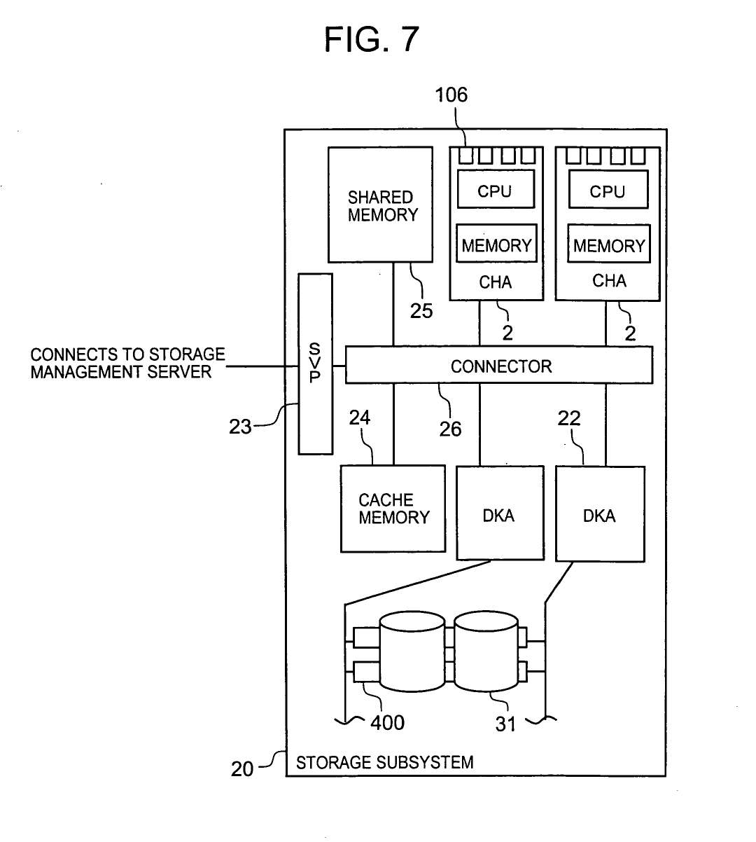

FIG. 7 shows an example of the constitution of a storage subsystem 20.

The storage subsystem 20 comprises a controller, and one or a plurality of physical storage devices (for example, a disk drive, such as a hard disk drive) 400. As a physical storage device 400, for example, it is possible to utilize devices, such as a hard disk, flexible disk, magnetic tape, semiconductor memory, optical disk, and so forth. One or more logical volumes 31 are provided on the one or plurality of physical storage devices 400. The controller, for example, comprises a plurality (for example, two) channel adapters (CHA) 2, a plurality of disk adapters (DKA) 22, a service processor (SVP) 23, cache memory 24, shared memory 25, and a connector 26.

Each CHA 2 is a device for carrying out data communication with a host computer 103, and comprises one or a plurality of communication ports 106. Each CHA 2 is constituted as a microcomputer system, comprising a CPU and memory, and interprets and executes a variety of commands received from a host computer 103. A WWN is allocated to the respective CHA 2 communication ports.

Each DKA 22 is a device for transmitting and receiving data to and from a physical storage device 400. A DKA 22, similar to a CHA 2, can be constituted as a microcomputer system comprising a CPU and memory. Each DKA 22 writes data to a physical storage device 400, and reads data from a physical storage device 400 in accordance with instructions from a CHA 2. When data is being inputted and outputted to and from a physical storage device 400, a DKA 22 converts a logical address to a physical address.

The SVP 23 is a computer system, which is operated for either maintaining or managing the storage subsystem 20, and, for example, is a notebook-type personal computer. The SVP 23 can be communicatively connected to the storage management server 101. Further, the storage management server 101 can also be communicatively connected to a CHA 2 or DKA 22, either in place of or in addition to the SVP 23.

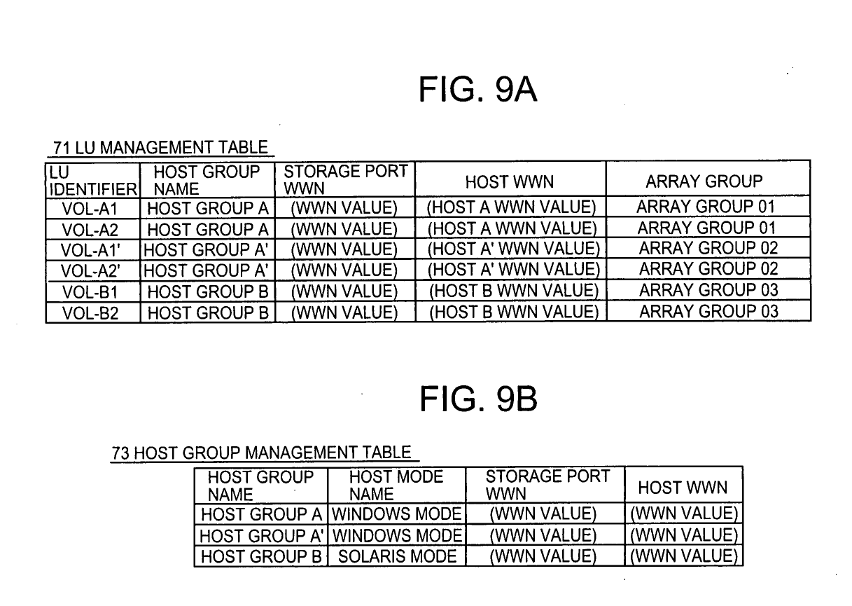

Cache memory 24 is for temporarily storing data received from a host computer 103, and data read out from a logical volume 31. Shared memory 25, for example, stores control information (for example, the tables given as examples in FIG. 9A and FIG. 9B, which will be explained hereinbelow) for controlling the operation of the storage subsystem 20. Cache memory 24 and shared memory 25 do not have to be separate memories, but rather can be a single memory.

The connector 26 mutually interconnects the respective CHA 2, respective DKA 22, SVP 23, cache memory 24, and shared memory 25. The connector 26, for example, can be constituted as a high-speed bus, such as an ultra-high-speed cross-bus switch, which carries out data transmission via high-speed switching operations. Further, the connector 26 can be constituted as a communications network, such as a LAN or SAN, and, it can also be constituted as the above-mentioned high-speed bus and a plurality of networks.

The various tables mentioned above will be explained hereinbelow. Furthermore, it is supposed that the values of the respective cells of the various tables correspond to FIG. 1.

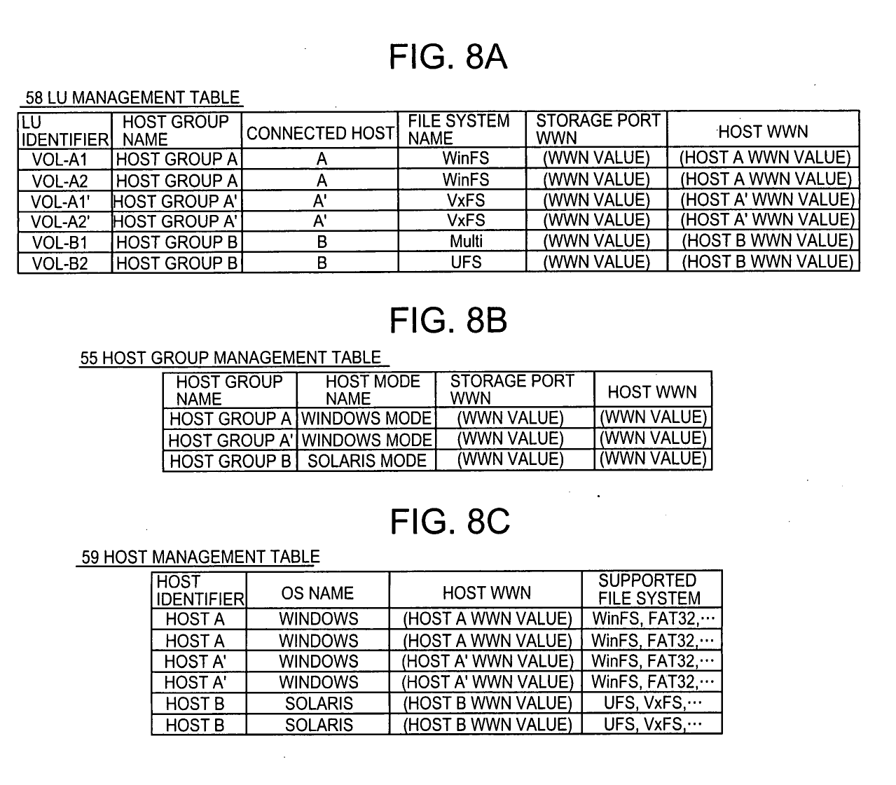

FIG. 8A shows an example of the constitution of an LU management table 58 inside the storage management server 101.

An LU identifier, host group name, identifier of a connected host, file system name, storage port WWN, and host WWN are recorded in a LU management table 58 for each logical volume (LU). The respective items will be explained taking logical volume VOL-A1 as a representative example. Host group name is the name of host group A, which has VOL-A1 as a component element. The identifier of the connected host is the identifier of host A, which recognizes VOl-A1. File system name is the name of the file system, which manages the files inside VOL-A1 (Furthermore, the file system, for example, can differ for each component of the same host group B, as shown by the records of VOL-B1 and VOL-B2.). The storage port WWN is the WWN of port 106, which permits access to VOL-A1 from host A. One or a plurality of WWN can be set here. The host WWN is the WWN of host A, which recognizes VOL-A1. For example, a plurality of host WWN can be set when host A has a plurality of host bus adapters.

FIG. 8B shows an example of the constitution of a host group management table 55 inside the storage management server 101.

A host group name, host mode name, storage port WWN and host WWN are recorded in the host group management table 55 for each host group. The respective items will be explained taking host group A as a representative example. Host group name is the name of host group A. Host mode name is the name of the host mode associated to host group A. The storage port WWN is the WWN of port 106, which is associated to host group A. The host WWN is the WWN of host A, which is associated to host group A.

FIG. 8C shows an example of the constitution of a host management table 59 inside the storage management server 101.

A host identifier, OS name, host WWN and supported file system are recorded in the host management table 59 for each host computer. The respective items will be explained taking host A as a representative example. The host identifier is the identifier of host A. The OS name is the name of the OS of host A. The host WWN is the WWN of host A. The supported file system is the name of the file system supported by the host A OS.

Furthermore, the reason there are two records for each host in this FIG. 8C is because each host has two WWN, but the constitution does not necessarily have to be like this. For example, two WWN can also be recorded in a single cell.

FIG. 9A shows an example of the constitution of an LU management table inside a storage subsystem 20.

An LU identifier, host group name, storage port WWN, host WWN, and array group name are recorded in the LU management table 71 for each logical volume (LU). In other words, the difference with the LU management table 58 of FIG. 8A is that an array group name is recorded without a connected host identifier and file system name. An array group is a group comprising a plurality of physical storage devices 400, which are constituted in accordance with the rules of RAID (Redundant Array of Independent (or Inexpensive) Disks), and can also be called a RAID group or a parity group. For example, the array group name with regard to VOL-A1 is the name of the array group comprising VOL-A1.

FIG. 9B shows an example of the constitution of a host group management table inside a storage subsystem.

A name, host mode, storage port WWN and host WWN are recorded in the host group management table 73 for each host group. The constitution of this table 73 is the same as the constitution of host group management table 55 given as an example in FIG. 8B.

The above-mentioned tables 71 and 73 are stored in CHA 2 memory, and access control to the respective logical volumes 31 can be carried out in the CHA 2. The tables 71 and 73 can also be loaded into CHA 2 memory from shared memory 25, and a specific table can be constituted for each CHA 2 (for example, a table, which only records information related to a logical volume under a CHA 2 and a host provided access by a CHA 2, but does not record information related to a logical volume under another CHA 2 and a host provided access by another CHA 2).

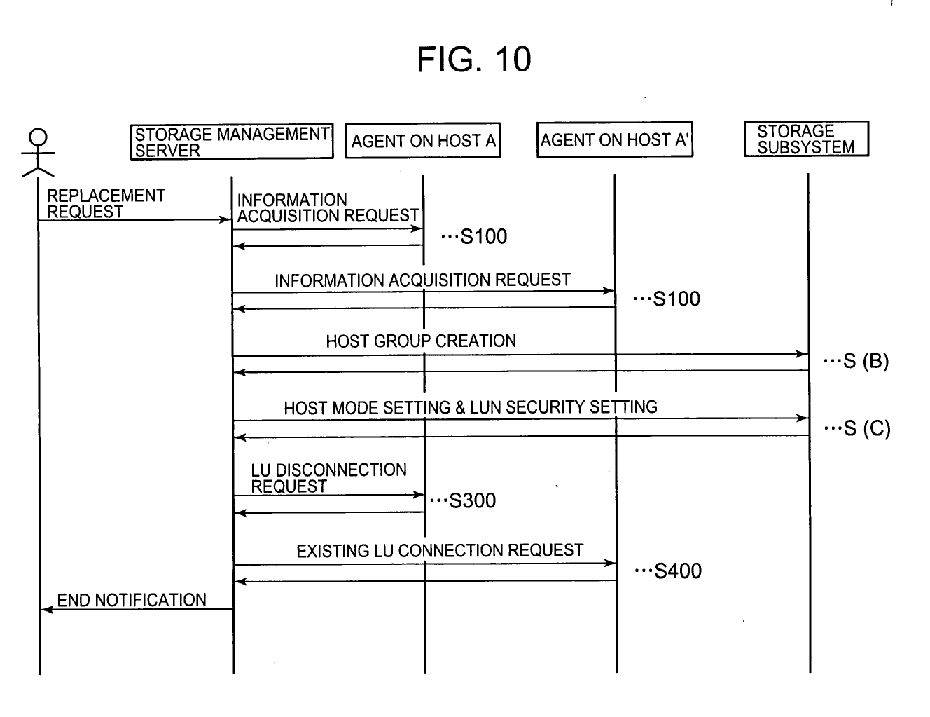

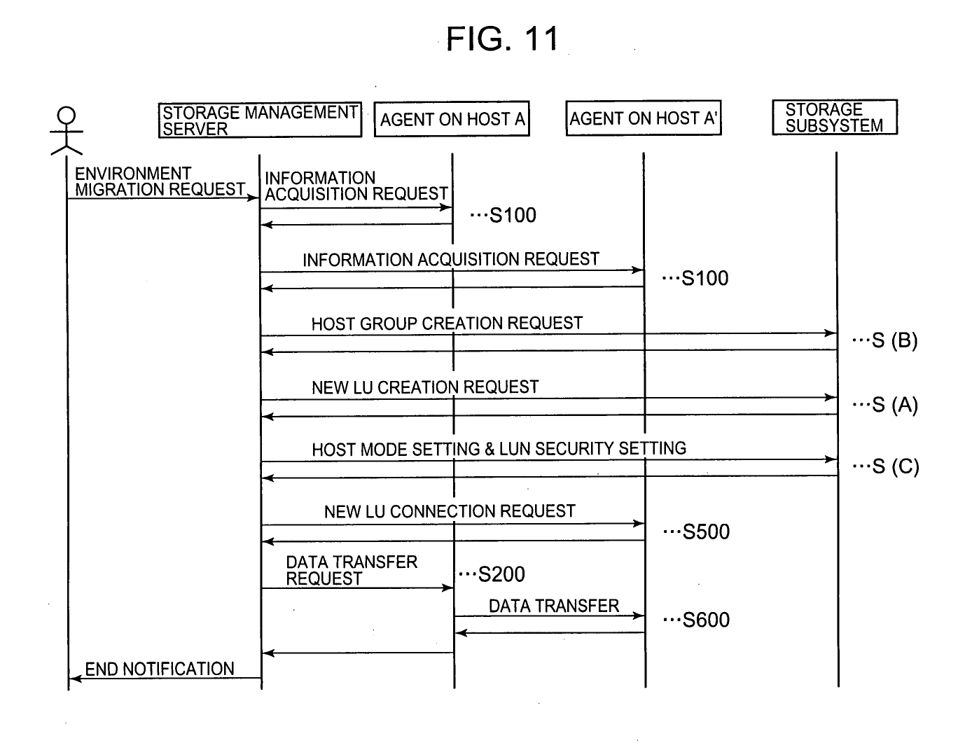

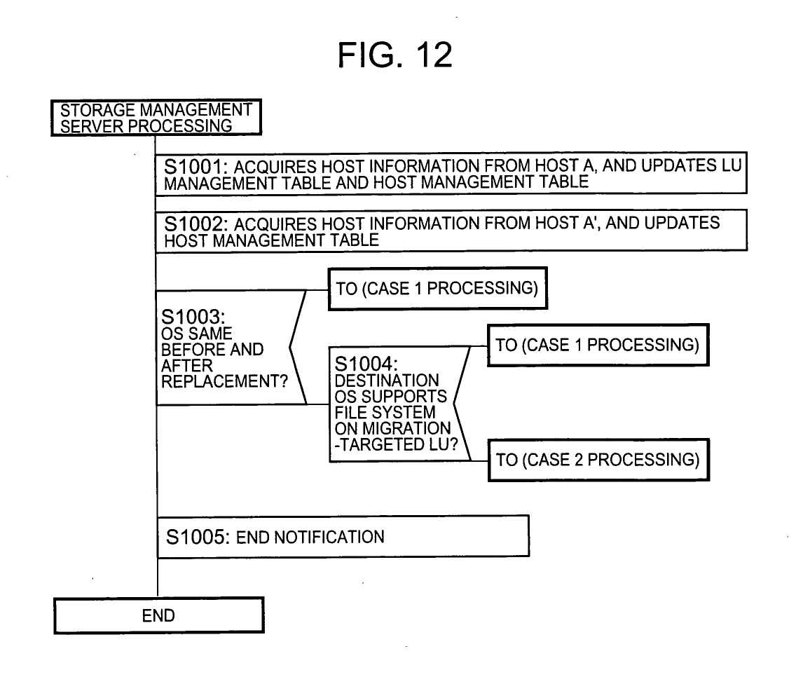

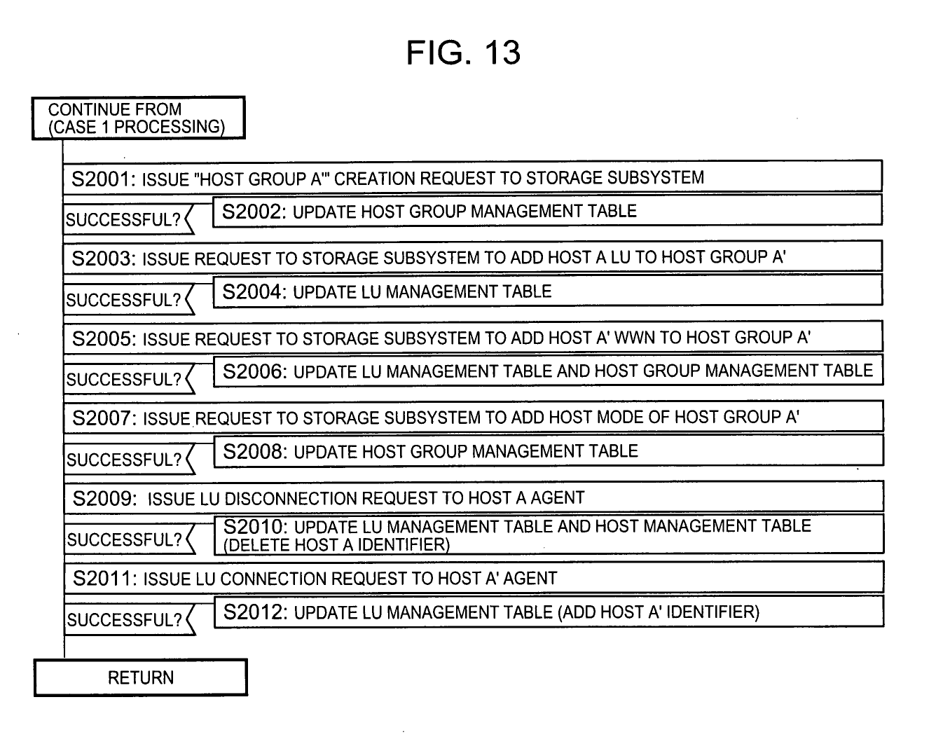

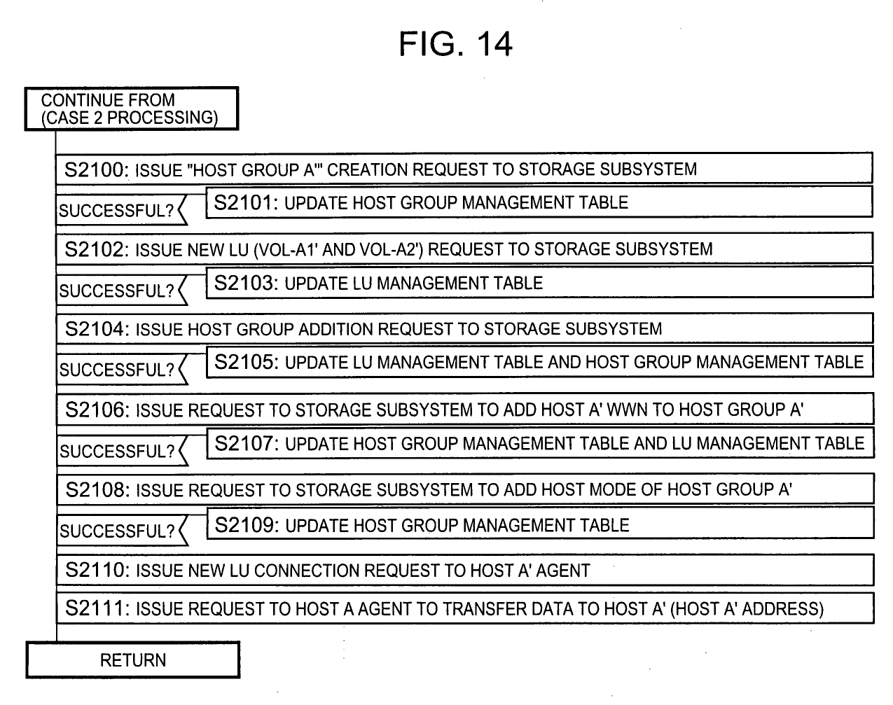

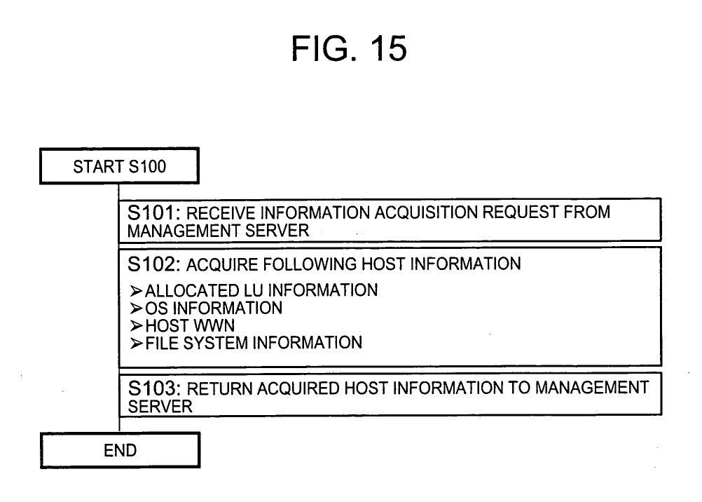

FIG. 10 shows an overview of the flows of S10, S20, S30 and S40 of FIG. 2 (that is, an overview of the flow when case 1 is executed). FIG. 11 shows an overview of the flows of S10, S20, S30 and S50 of FIG. 2 (that is, an overview of the flow when case 2 is executed). FIG. 12 shows an overview of the overall processing flow carried out by the storage management server 101. FIG. 13 shows the flow of processing performed by the storage management server in the processing of case 1. FIG. 14 shows the flow of processing performed by the storage management server in the processing of case 2. The flow of processing performed by this embodiment will be explained in detail below by referring to these figures. Furthermore, in the following explanation, FIGS. 12 through 14 will be used mainly, and FIG. 10, FIG. 11, and FIGS. 15 through 20 will be referenced as needed. Further, in the following explanation, it is supposed that the host group management table 73 inside the storage subsystem 20 has been acquired by the storage management server 101, and that a host group management table 55, like the one given as an example in FIG. 8B, is stored in the storage management server 101 (However, information regarding host group A′ is not recorded.). Further, it is supposed that the LU management table 58 (FIG. 8A) and the host management table 59 (FIG. 8C) inside the storage management server 101 are completely blank. Further, it is supposed that there are no records for host group A′ in the LU management table 71 (FIG. 9A) and the host group management table 73 (FIG. 9B) inside the storage subsystem 20.

An administrator, using, for example, a GUI, sends a host A-to-host A′ replacement instruction (for example, an instruction comprising the host A identifier and the host A′ identifier) to the storage management server 101.

The storage management server 101 carries out S1001 of FIG. 12. That is, the manager 51 of the storage management server 101 responds to the above-mentioned replacement instruction, and sends an information acquisition request to the agent of host A, which can be specified from this replacement instruction. S100 of FIG. 10 and FIG. 11 is thereby carried out. More specifically, the host A agent, as shown in the example of FIG. 15, responds to the receipt of an information acquisition request (S101), reads out from the host A storage resource host information, comprising LU information (for example, the LU identifier of a logical volume that is recognized by host A), OS information (for example, the OS name of the host A OS), host WWN (the WWN of host A), and file system information (for example, the name of the file system utilized and supported by the host A OS) (S102), and returns the read host information to the storage management server 101 (S103). The storage management server 101 uses the information elements inside the received host information to update the LU management table 58 and the host management table 59.

More specifically, for example, the manager 51 of the storage management server 101 records the LU identifiers Vol-A1 and VOL-A2 inside the LU information in the LU management table 58. Further, the manager 51 acquires from the host group management table 55 the host group name that coincides with the received host WWN, and makes the acquired host group name correspond to VOL-A1 and VOL-A2 on the LU management table 58. The manager 51 also makes the host A identifier correspond to VOL-A1 and VOL-A2 on the LU management table 58. Further, the manager 51 makes the file system name in the received file system information correspond to VOL-A1 and VOL-A2 on the LU management table 58. The manager 51 also acquires from the host group management table 55 the storage port WWN that coincides with the received host WWN, and makes the acquired storage port WWN correspond to VOL-A1 and VOL-A2 on the LU management table 58. Further, the manager 51 makes the received host WWN correspond to VOL-A1 and VOL-A2 on the LU management table 58. This completes the updating of the LU management table 58. The manager 51 also makes the host A identifier, the OS name in the received OS information, the received host WWN, and the supported file system name in the received file system information correspond in the host management table 59. This completes the updating of the host management table 59.

Next, the storage management server 101 executes the processing of S1002 of FIG. 12. More specifically, the manager 51 sends an information acquisition request to the agent of host A′ specifiable from the above-mentioned replacement instruction. The above-mentioned S100 is thereby performed for host A′ as well, and the manager 51 receives host information from this agent. The manager 51 uses this host information to update the host management table 59. The reason the LU management table 58 is not updated here is because in this embodiment host A′ still does not recognize any logical volumes. Records like those in the third and fourth rows of FIG. 8C are recorded in the host management table 59 for host A′ from the received OS information, host WWN and file system information.

The storage management server 101 makes a determination as to whether or not the type of OS in host A and host A′ is the same by comparing the OS information acquired in S1001 against the OS information acquired in S1002 (S1003 of FIG. 12). If the result is that the OS type is the same, the storage management server 101 executes the case 1 processing of FIG. 13.

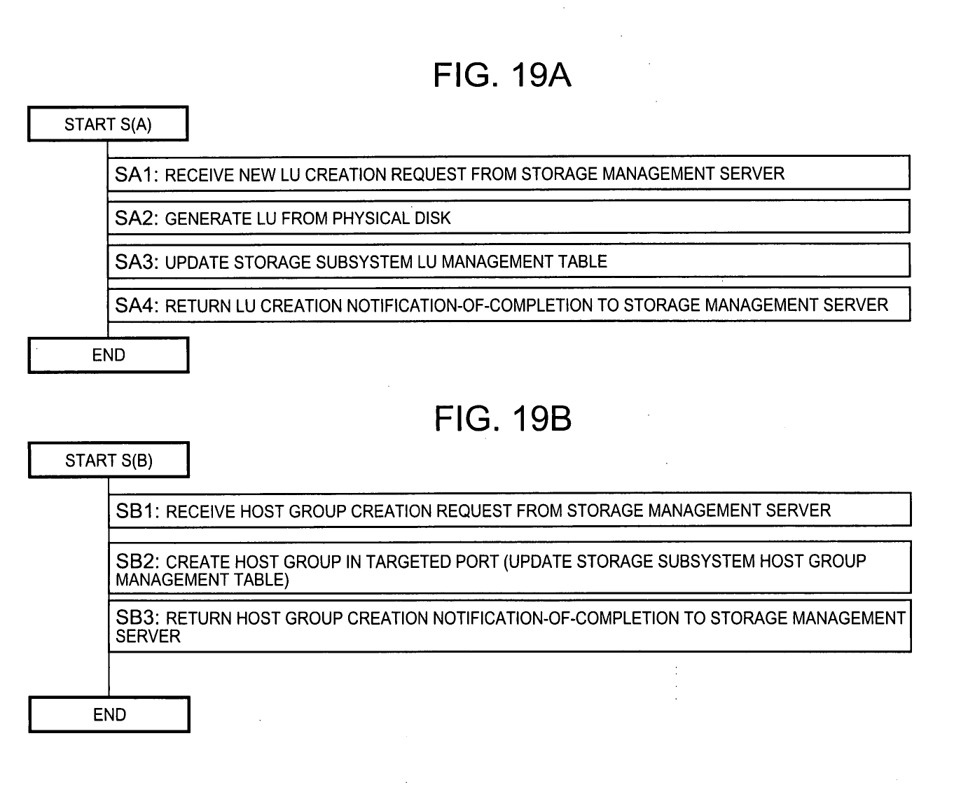

More specifically, the manager 51 issues a host group A′ creation request (for example, a request comprising the storage port WWN and host group name) to the storage subsystem 20 (S2001 of FIG. 13). S(B) of FIG. 10 is thereby carried out. More specifically, as shown in the example of FIG. 19B, the storage subsystem 20 responds to the host group creation request (SB1), and creates host group A′ (for example, a host group having the host group name comprised in the above-mentioned creation request) in the targeted port 106 (for example, a port corresponding to the storage port WWN comprised in the above-mentioned creation request) (SB2). In other words, storage subsystem 20 writes the storage port WWN and name of the host group A′ to the host group management table 73. When this is done, the storage subsystem 20 returns a notification-of-completion to the storage management server 101 (SB3). The manager 51, upon receiving the notification-of-completion, writes the storage port WWN and name of host group A′ in the above-mentioned creation request to the host group management table 73 (S2002 of FIG. 13).

Next, as shown in FIG. 10, the manager 51 makes the host mode setting and LUN security setting in the storage subsystem 20, carrying out S(C). This will be explained more specifically hereinbelow.

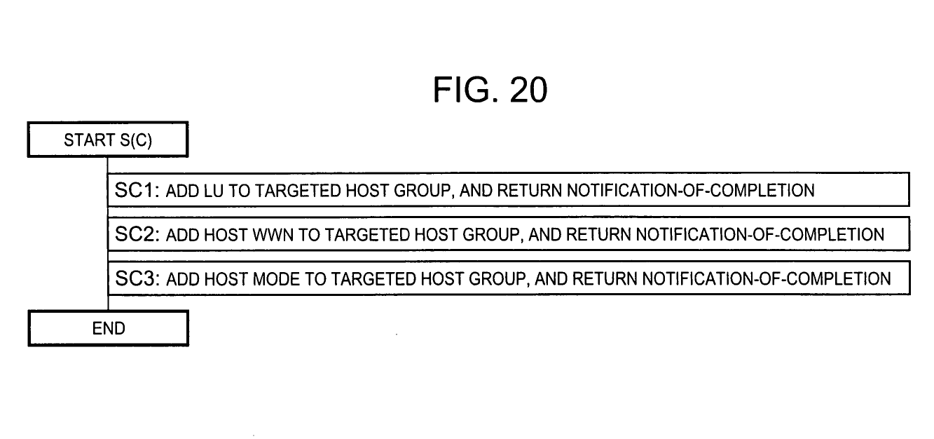

The manager 51 issues to the storage subsystem 20 an LU addition request to add host A-recognized VOL-A1 and VOL-A2 to host group A′ (for example, a request comprising the name of host group A′, and the LU identifier of VOL-A1 and VOL-A2) (S2003 of FIG. 13). SC1 of FIG. 20 is thereby performed. That is, the storage subsystem 20 responds to the LU addition request, and adds VOL-A1 and VOL-A2 (the LU corresponding to the LU identifiers comprised in the LU addition request) to the targeted host group A′ (the host group having the host group name comprised in the LU addition request). In other words, the storage subsystem 20 overwrites the storage port WWN and host group A′ name written in SB3 of FIG. 19B in the column corresponding to the LU identifier of VOL-A1 and VOL-A2 in LU management table 71. The storage subsystem 20, upon finishing this, returns a notification-of-completion to the storage management server 101. When the manager 51 receives the notification-of-completion, it makes the information inside the LU addition request (the LU identifier of VOL-A1 and VOL-A2) correspond to the host group A′ name on the LU management table 58 (S2004 of FIG. 13).

Next, the manager 51 issues an addition request comprising the host WWN of host A′ to the storage subsystem 20 (S2005 of FIG. 13). SC2 of FIG. 20 is thereby carried out. That is, the storage subsystem 20 responds to the addition request and adds the host WWN (that is, the WWN of host A′) in the above-mentioned addition request to the targeted host group A′ (the host group having the host group name that was added in SB3 of FIG. 19B and SC1 of FIG. 20). In other words, the storage subsystem 20 writes the WWN of host A′ in the column corresponding to the name of host group A′ in the LU management table 71 and host group management table 73. Upon finishing this, the storage subsystem 20 returns a notification-of-completion to the storage management server 101. The manager 51, upon receiving the notification-of-completion, makes the information inside the above-mentioned addition request (host A′ WWN) correspond to the name of the host group A′ in the LU management table 58 and host group management table 55 (S2006 of FIG. 13).

Next, the manager 51 issues an addition request comprising the host mode name of host A′ to the storage subsystem 20 (S2007 of FIG. 13). SC3 of FIG. 20 is thereby carried out. That is, the storage subsystem 20 responds to the addition request, and adds the host mode name (that is, the host mode name of host A′) in the above-mentioned addition request to the targeted host group A′. In other words, the storage subsystem 20 writes the host mode name of host A′ in the column corresponding to the name of host group A′ in the LU management table 71 and host group management table 73. Once this is finished, the storage subsystem 20 returns a notification-of-completion to the storage management server 101. The manager 51, upon receiving the notification-of-completion, makes the information in the above-mentioned addition request (the host mode name of host A′) correspond to the name of host group A′ in the host group management table 55 (S2008 of FIG. 13).

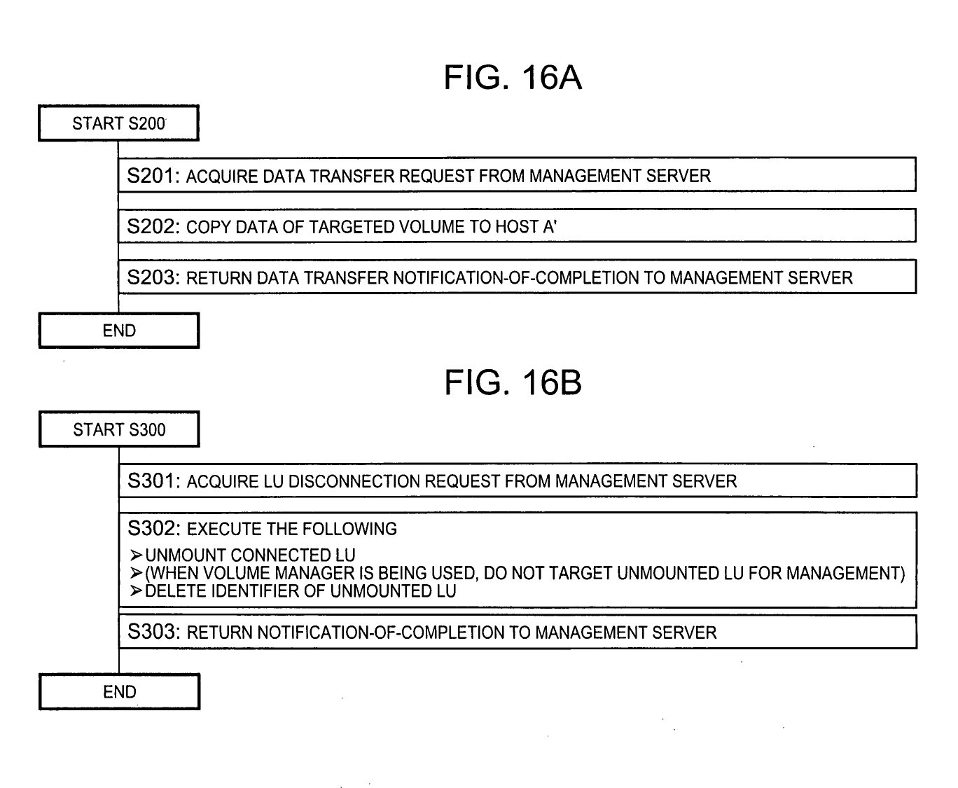

Next, the manager 51, as shown in FIG. 10 and FIG. 13, sends an LU disconnection request (a request to the host A agent to disconnect the recognized LU (here VOL-A1 and VOL-A2)) (S2009 of FIG. 13). The processing of FIG. 16B (S300) is thereby carried out. That is, the host A agent responds to this request (S301), unmounts the connected (in other words, recognized) LU, and deletes the identifier of the unmounted LU from the host A storage resource. Also, thereafter, when the volume manager is being utilized, the agent instructs this volume manager to cease managing the unmounted LU. When the above-mentioned operation is finished, the agent returns a notification-of-completion of LU disconnection to the storage management server 101 (S303). The storage management server 101, upon receiving this notification-of-completion, deletes the identifier of host A, from which the LU (here, VOL-A1 and VOL-A2) was disconnected from the LU management table 58 and host management table 59 (S2020 of FIG. 13).

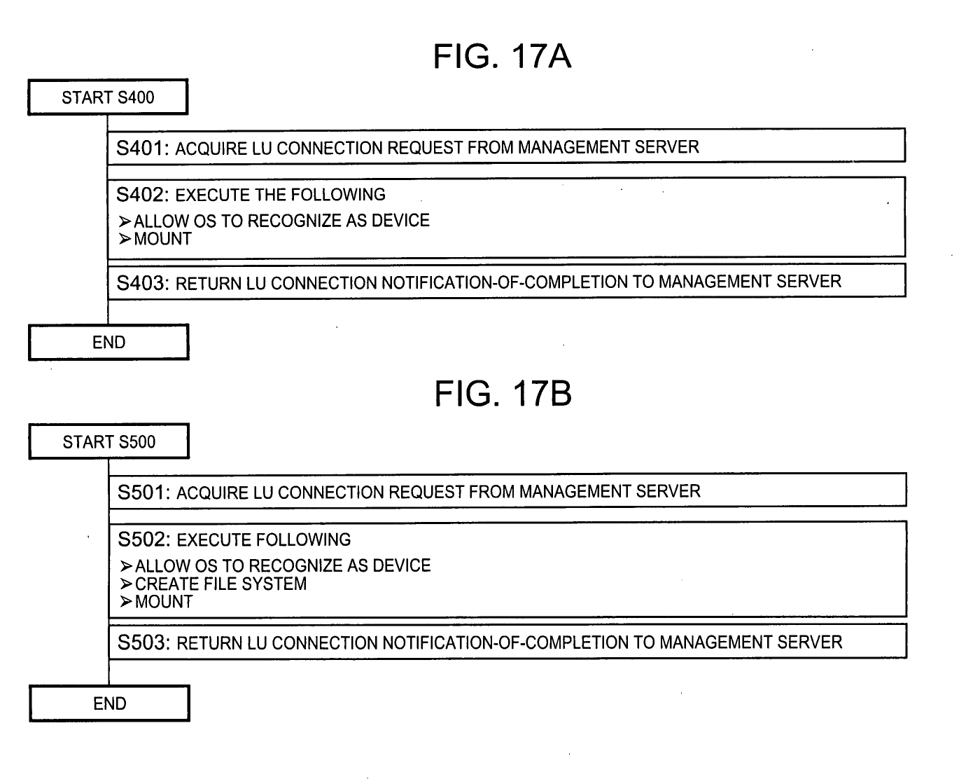

Next, the storage management server 101 sends a connection request for an existing LU (here, a request comprising the identifiers of VOL-A1 and VOL-A2) to the agent of host A′, the replacement destination, as shown in FIG. 10 and FIG. 13 (S2011 of FIG. 13). The processing of FIG. 17A (S400) is thereby carried out. That is, the host A′ agent responds to this request (S401), allows the OS of host A′ to recognize VOL-A1 and VOL-A2 as devices (for example, makes the storage subsystem 20 query the existence of VOL-A1 and VOL-A2), and mounts VOL-A1 and VOL-A2. When this is finished, the agent returns a notification-of-completion of LU connection to the storage management server 101 (S403). The storage management server 101, upon receiving this notification-of-completion, makes the identifier of host A′ correspond to the identifier of VOL-A1 and VOL-A2 in the LU management table 58 (S2012 of FIG. 13).

The storage management server 101, once S2012 of FIG. 13 has been finished, sends an end-notification to the manager (S1005 of FIG. 12, for example, displays a message to the effect that the operation has ended). The continuous flow of FIG. 10 thereby ends.

Now then, when S1003 of FIG. 12 determines that the OS type is not the same, the storage management server 101 makes a determination as to whether or not the host A′ OS supports the file system on the volume recognized by host A by comparing the file system information acquired in S1001 against the file system information acquired in S1002 (S1004). When it is determined that this file system is supported, the storage management server 101 executes case 1 processing of FIG. 13 (that is, the processing explained hereinabove), and when it is determined that this file system is not supported, executes case 2 processing of FIG. 14.

More specifically, the manager 51 issues a host group A′ creation request to the storage subsystem 20 (S2100 of FIG. 14). S(B) of FIG. 10 (FIG. 19B) is thereby carried out, and the same processing as S2002 of FIG. 13 (S2101 of FIG. 14) is carried out.

Next, the manager 51 issues a new LU creation request to the storage subsystem 20 (S2102 of FIG. 14). This creation request, for example, comprises the LU identifier of the new LU (VOL-A1′ and VOL-A2′), the name of the array group comprising the new LU, the storage capacity of the new LU, and other information required to create a new LU (Furthermore, it is supposed that the storage capacity of the new LU, for example, is at least the same as the storage capacity of the existing LU or larger.). S(A) is carried out by the storage subsystem 20. The processing of S(A) will be explained by referring to FIG. 19A. The storage subsystem 20 responds to the new LU creation request (SA1), and uses the array group having the name of the array group in this creation request to create an LU having the LU identifier in this creation request (SA2), and records this LU identifier and array group name in the LU management table 71 (SA3). When it finishes this, the storage subsystem 20 returns a notification-of-completion to the storage management server 101 (SA4). The manager 51, upon receiving this notification-of-completion, records the LU identifier of the new LU (VOL-A1′ and VOL-A2′) in the LU management table 58 (S2103 of FIG. 14).

Next, the manager 51 performs the host mode setting and LUN security setting in the storage subsystem 20, and carries out S(C) as shown in FIG. 11. In other words, substantially the same processing as that of S2003 through S2008 of FIG. 13 is carried out (S2104 through S2109 of FIG. 14). The explanation for this is the same as the explanation of case 1 processing. In the processing of case 2, host group A′ is associated to the created new LU (VOL-A1′ and VOL-A2′) (More specifically, the name of the host group A′ is made to correspond to the LU identifier of VOL-A1′ and VOL-A2′ on the LU management tables 71 and 58.).

Next, the manager 51 sends a connection request for connecting the new LU (here, a request comprising the identifier of VOL-A1′ and VOL-A2′) to the agent of host A′, which is the replacement destination, as shown in FIG. 11 and FIG. 14 (S2110 of FIG. 14). The processing of FIG. 17B (S500) is thereby carried out. That is, the host A′ agent responds to this connection request (S501), allows the OS of host A′ to recognize VOL-A1′ and VOL-A2′ as devices (for example, makes the storage subsystem 20 query the existence of VOL-A1′ and VOL-A2′), creates a file system for VOL-A1′ and VOL-A2′, and mounts VOL-A1′ and VOL-A2′. When it finishes this, the agent returns an LU connection notification-of-completion to the storage management server 101 (S503). The storage management server 101, upon receiving this notification-of-completion, makes the host A′ identifier correspond to the identifier of VOL-A1′ and VOL-A2′ in the LU management table 58.

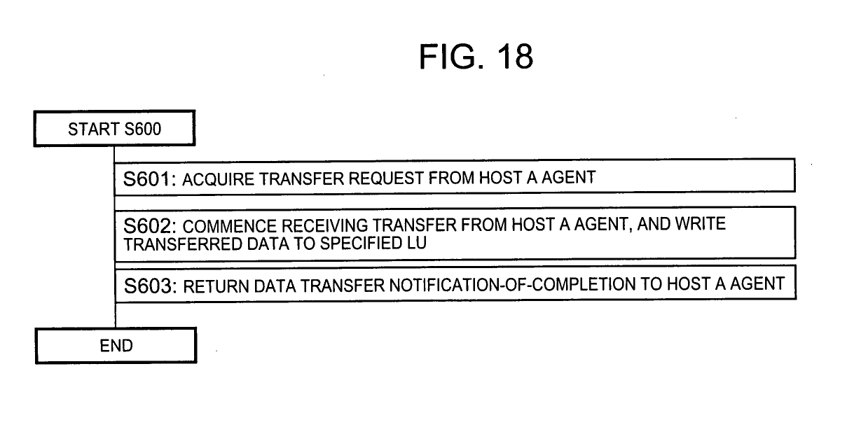

Next, the manager 51 issues a data transfer request to the host A agent (for example, a request comprising the respective LU identifiers of the transfer origin and the transfer destination, and the identifier of the host of the transfer destination) as shown in FIG. 11 and FIG. 14 (S2110 of FIG. 14). The processing of FIG. 16A (S200) is thereby carried out. That is, the host A agent responds to the data transfer request (S201), issues a transfer request to host A′, reads data from the LU (VOL-A1 and VOL-A2) of the transfer origin specified from this data transfer request, specifies the LU identifier of the transfer destination LU (VOL-A1′ and VOL-A2′) specified from this data transfer request, and transfers the read data to host A′ (S202). The host A′ agent, as shown in the example of FIG. 18, responds to the transfer request (S601), commences receiving the data, writes the transferred data to the transfer destination LU (VOL-A1′ and VOL-A2′) (S602), updates the newly created file system at this time, and, when it has finished writing all the data, returns a notification-of-completion to the host A agent (S603). The host A agent, upon receiving this notification-of-completion, returns a notification-of-completion to the storage management server 101 (S203 of FIG. 16A).

The storage management server 101, upon finishing S200 of FIG. 14, sends an end-notification to the administrator (S1005 of FIG. 12, for example, displays a message to the effect that the process has ended). The consecutive flow of FIG. 11 thereby comes to an end. In case 2, host A′ is able to recognize the data inside VOL-A1′ and VOL-A2′, that is, the host A-recognizable data inside VOL-A1 and VOL-A2, by referencing the updated file system.

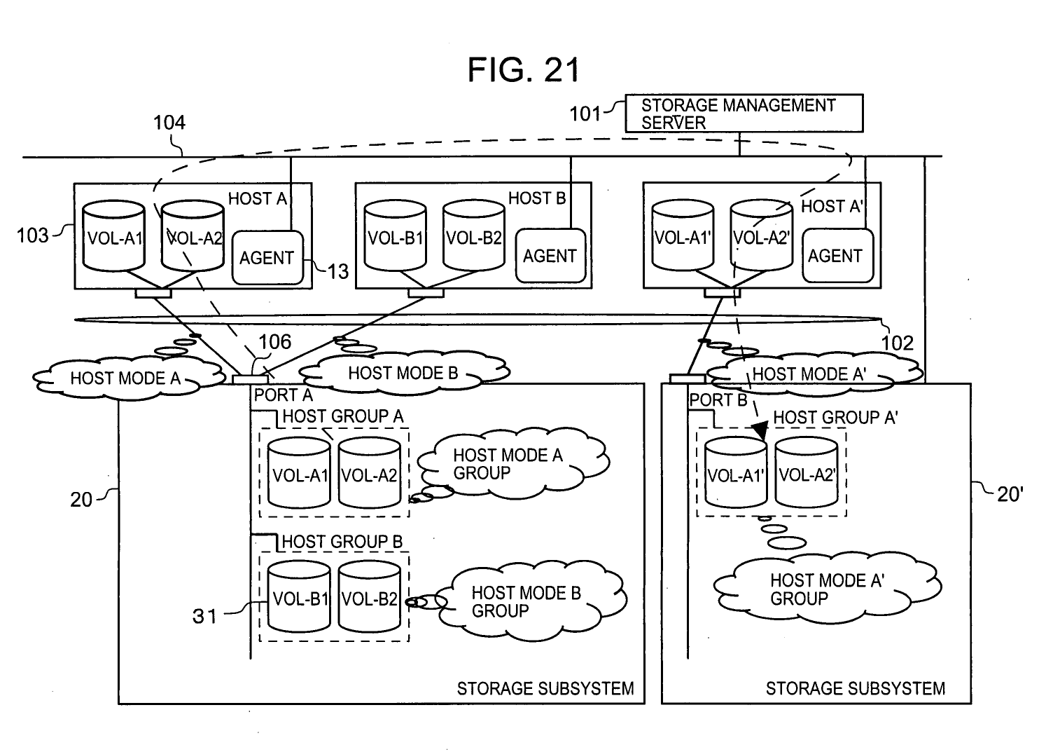

The preferred embodiment of the present invention has been explained hereinabove, but this embodiment was given as an example for explaining the present invention, and the scope of the present invention is not limited solely to this embodiment. The present invention can be put into practice in a variety of other forms. For example, in the above-mentioned embodiment, the determination as to whether or not the volume format of host A is supported by host A′ was carried out by comparing the information of the file systems, but this can be carried out by another method, for example, by comparing information related to volume managers (for example, names, and so forth). Further, in the case 2 processing, as shown in FIG. 21, the new LU (VOL-A1′ and VOL-A2′) can be prepared in another storage subsystem 20′. At that time, for example, the identifier of the other storage subsystem 20′ can be specified in a host group creation request. Further, in case 1, LU replacement is carried out, but a new LU (VOL-A1′ and VOL-A2′) can be created in either the storage subsystem or the other storage subsystem, and the data inside the existing LU (VOL-A1 and VOL-A2) can either be copied or migrated between LUs to this new LU without going through the hosts A and A′. Also, in case 2, the disconnection of existing LU (VOL-A1 and VOL-A2) from host A can be carried out. At least one of the processes of S(A), S(B), or S(C) can be carried out by the CHA 2, DKA 22 or SVP 23.

What is claimed is:

1. A management computer communicatively connected to first and second host computers, which input and output data to and from a connected logical volume, and to one or more storage subsystems which comprise a storage subsystem having a first logical volume connected to said first host computer, and a controller for controlling inputting and outputting to said first logical volume by said first host computer, the management computer comprising:
a first host information acquisition part for acquiring from said first host computer a first host information by requesting said first host computer for said first host information, which denotes a first data processing environment in said first host computer;
a second host information acquisition part for acquiring from said second host computer a second host information by requesting said second host computer for said second host information, which denotes a second data processing environment in said second host computer;
a comparator for comparing the acquired said first host information with said second host information; and
an environment setting part for automatically performing, in accordance with the results of said comparison, an environment setting for said second host computer and either said storage subsystem or said other storage subsystem, for making the data inside said first logical volume recognizable to said second host computer.

2. The management computer according to claim 1, wherein at least the controller of said storage subsystem comprises a storage region;
said storage region stores, for each volume group constituting one or more logical volumes corresponding to the respective host computers, a group ID of a volume group, a volume ID of the one or more logical volumes constituting the volume group, and input/output format information denoting the input/output format of the host computer corresponding to the volume group;
said controller is constituted so as not to perform inputting or outputting to or from a logical volume constituting a volume group using an input/output format other than the input/output format denoted by the input/output format information associated to the volume group;
OS information related to the OS of said second host computer is included in said second host information; and
said environment setting part sends a host group creation request for preparing a new host group corresponding to said second host computer to either said storage subsystem or said other storage subsystem, and sends an input/output format information setting request based on OS information in said second host information to the transmission destination of said host group creation request, thereby, either the controller of said storage subsystem or the controller of said other storage subsystem adds a new group ID denoting said new host group to said storage region, and associates said setting-requested input/output format information to the new group ID.

3. The management computer according to claim 2, wherein
each of said one or more storage subsystems comprises a plurality of communication ports;
said storage region stores a port ID of a communication port for each of said volume groups;
said controller is constituted so as not to allow input/output via a communication port corresponding to a port ID, which is not associated to a volume group, even if input/output is performed via an input/output format denoted by input/output format information associated to this volume group; and
said environment setting part sends a port ID setting request to the transmission destination of said host group creation request, thereby, either the controller of said storage subsystem or the controller of said other storage subsystem associates said setting-requested port ID to said new group ID.

4. The management computer according to claim 1, wherein at least the controller of said storage subsystem comprises a storage region;
said storage region stores, for each logical volume, a volume ID of a logical volume, and a host ID of a host computer for which an input/output format to the logical volume is permitted;
said controller is constituted so as not to perform inputting or outputting to or from a logical volume in a host computer other than a host computer, which has a host ID associated to said logical volume;
the host ID of said second host computer is included in said second host information; and
said environment setting part sends a volume ID of a logical volume, which is recognized by said second host computer, to either said storage subsystem or said other storage subsystem, and sends a setting request of a host ID in said second host information to the transmission destination of said volume ID, thereby, either the controller of said storage subsystem or the controller of said other storage subsystem associates said setting-requested host ID to a received volume ID in said storage region.

5. The management computer according to claim 1, wherein, when in accordance with the results of said comparison said first data processing environment is supported by said second host computer, said environment setting part sends to said first host computer a disconnection request for disconnecting said first logical volume inside said storage subsystem, and sends to said second host computer a connection request for connecting said first logical volume, thereby, said first logical volume is disconnected from said first host computer, and said first logical volume is connected to said second host computer.

6. The management computer according to claim 5, wherein a first OS type information, which denotes the type of a first OS of said first host computer, is included in said first host information;
a second OS type information, which denotes the type of a second OS of said second host computer, is included in said second host information; and
when said first data processing environment is supported by said second host computer, the second OS type denoted by said second OS type information is compatible with the first OS type denoted by said first OS type information.

7. The management computer according to claim 6, wherein
a first volume format information, which denotes a first volume format supported by said first OS, is included in said first host information;
a second volume format information, which denotes the second volume format supported by said second OS, is included in said second host information; and
when the second volume format denoted by said second volume format information supports the first volume format denoted by said first volume format information, even if the second OS type denoted by said second OS type information is not compatible with the first OS type denoted by said first OS type information, said first data processing environment is still supported by said second host computer.

8. The management computer according to claim 7, wherein said volume format is an OS-supported file system and/or a volume manager.

9. The management computer according to claim 5, wherein
at least the controller of said storage subsystem comprises a storage region;
said storage region stores, for each volume group constituting one or more logical volumes corresponding to the respective host computers, a group ID of a volume group, a volume ID of the one or more logical volumes constituting the volume group, and input/output format information denoting the input/output format of the host computer corresponding to the volume group;
said controller is constituted so as not to perform inputting or outputting to or from a logical volume constituting a volume group using an input/output format other than the input/output format denoted by the input/output format information associated to the volume group;
OS information related to the OS of said second host computer is included in said second host computer information; and
said environment setting part sends a host group creation request for preparing a new host group corresponding to said second host computer to said storage subsystem, sends an input/output format information setting request based on OS information in said second host information to the storage subsystem, and sends the volume ID of said first logical volume to the storage subsystem, thereby, the controller of said storage subsystem adds a new group ID denoting said new host group to said storage region, and associates to this new group ID said setting-requested input/output format information and the volume ID of said first logical volume.

10. The management computer according to claim 1, wherein, when in accordance with the results of said comparison said first data processing environment is supported by said second host computer, said environment setting part causes either said storage subsystem or another storage subsystem to prepare a new second logical volume, and to write data inside said first logical volume to said second logical volume without going through at least said second host computer, and sends to said second host computer a connection request for connecting said second logical volume, thereby, said second logical volume, to which the data inside said first logical volume has been written, is connected to said second host computer.

11. The management computer according to claim 10, wherein
at least the controller of said storage subsystem comprises a storage region;
said storage region stores, for each volume group constituting one or more logical volumes corresponding to the respective host computers, a group ID of a volume group, a volume ID of the one or more logical volumes constituting the volume group, and input/output format information denoting the input/output format of the host computer corresponding to the volume group;
said controller is constituted so as not to perform inputting or outputting to or from a logical volume constituting a volume group using an input/output format other than the input/output format denoted by the input/output format information associated to the volume group;
OS information related to the OS of said second host computer is included in said second host information; and
said environment setting part sends a host group creation request for preparing a new host group corresponding to said second host computer to either said storage subsystem or said other storage subsystem, sends an input/output format information setting request based on OS information in said second host information to the transmission destination of said host group creation request, and sends the volume ID of said second logical volume to the transmission destination of said host group creation request, thereby, either the controller of said storage subsystem or the controller of said other storage subsystem adds a new group ID denoting said new host group to said storage region, and associates to the new group ID said setting-requested input/output format information and the volume ID of said second logical volume.

12. The management computer according to claim 1, wherein, when in accordance with the results of said comparison, said first data processing environment is not supported by said second host computer, said environment setting part causes either said storage subsystem or another storage subsystem to prepare a new second logical volume, and to connect said prepared second logical volume to said second host computer, causes said second host computer to create a file system for recognizing a data file written to said second logical volume, and causes said first host computer to read out all data inside said first logical volume and transfer the same to said second host computer, thereby, when said second host computer writes said transferred data to said second logical volume, and updates said created file system accordingly, and all data inside said first logical volume is written to said second logical volume, the data inside said second logical volume can be recognized using said updated file system.

13. The management computer according to claim 12, wherein, when in accordance with the results of said comparison, said first data processing environment is supported by said second host computer, said environment setting part sends to said first host computer a disconnection request for disconnecting said first logical volume inside said storage subsystem, and sends to said second host computer a connection request for connecting said first logical volume, thereby, said first logical volume is connected to said second host computer.

14. The management computer according to claim 12, wherein, when in accordance with the results of said comparison, said first data processing environment is supported by said second host computer, said environment setting part causes either said storage subsystem or another storage subsystem to prepare a new second logical volume, and to write data inside said first logical volume to said second logical volume without going through at least said second host computer, and sends to said second host computer a connection request for connecting to said second logical volume, thereby, said second logical volume, to which the data inside said first logical volume is written, is connected to said second host computer.

15. The management computer according to claim 12, wherein,
at least the controller of said storage subsystem comprises a storage region;
said storage region stores, for each volume group constituting one or more logical volumes corresponding to the respective host computers, a group ID of a volume group, a volume ID of one or more logical volumes constituting the volume group, and input/output format information denoting the input/output format of the host computer corresponding to the volume group;
said controller is constituted so as not to perform inputting or outputting to or from a logical volume constituting a volume group using an input/output format other than the input/output format denoted by the input/output format information associated to the volume group;
OS information related to the OS of said second host computer is included in said second host information; and
said environment setting part sends a host group creation request for preparing a new host group corresponding to said second host computer to either said storage subsystem or said other storage subsystem, sends an input/output format information setting request based on OS information in said second host information to the transmission destination of said host group creation request, and sends the volume ID of said second logical volume to the transmission destination of said host group creation request, thereby, either the controller of said storage subsystem or the controller of said other storage subsystem adds a new group ID denoting said new host group to said storage region, and associates to the new group ID said setting-requested input/output format information and the volume ID of said second logical volume.

16. A method achieved by a computer system comprising:
first and second host computers for inputting and outputting data to and from a connected logical volume; and
one or more storage subsystems comprising a storage subsystem having a first logical volume connected to said first host computer, and a controller for controlling inputting and outputting to and from said first logical volume by said first host computer,
the method comprising the steps of:
acquiring from said first host computer first host information denoting a first data processing environment in said first host computer;
acquiring from said second host computer second host information denoting a second data processing environment in said second host computer;
comparing the acquired said first host information with said second host information; and
setting automatically, in accordance with said comparison, an environment for said second host computer and either said storage subsystem or said other storage subsystem, for making data inside said first logical volume recognizable to said second host computer.

17. A computer program for executing on a computer, which is communicatively connected to first and second host computers for inputting and outputting data to and from a connected logical volume, and one or more storage subsystems comprising a storage subsystem having a first logical volume connected to said first host computer, and a controller for controlling inputting and outputting to and from said first logical volume by said first host computer, the steps of:
acquiring from said first host computer first host information by requesting said first host computer for said first host information, which denotes a first data processing environment in said first host computer;
acquiring from said second host computer a second host information by requesting said second host computer for said second host information, which denotes a second data processing environment in said second host computer;
comparing the acquired said first host information with said second host information; and
performing automatically, in accordance with the results of said comparison, an environment setting for said second host computer and either said storage subsystem or said other storage subsystem, for making the data inside said first logical volume recognizable to said second host computer.

18. A method achieved by a computer system comprising:
first and second host computers for inputting and outputting data to and from a connected logical volume; and
one or more storage subsystems comprising a storage subsystem having a first logical volume connected to said first host computer, a controller for controlling inputting and outputting to and from said first logical volume by said first host computer, and a plurality of communication ports, wherein
at least the controller of said storage subsystem comprises a storage region;
said storage region stores, for each volume group constituting one or more logical volumes corresponding to the respective host computers, a group ID of a volume group, a volume ID of the one or more logical volumes constituting the volume group, input/output format information denoting the input/output format of the host computer corresponding to the volume group, and a port ID of a communication port, and a plurality of group IDs are associated to one port ID in the storage region; and
said controller is constituted so as not to perform inputting or outputting to or from a logical volume constituting a volume group using an input/output format other than the input/output format denoted by the input/output format information associated to the volume group, and wherein
the method comprises the steps of:
acquiring from said first host computer first host information by requesting said first host computer for said first host information, which denotes a first data processing environment in said first host computer;
acquiring from said second host computer second host information by requesting said second host computer for said second host information, which denotes a second data processing environment in said second host computer, and which comprises OS information related to the OS of said second host computer; and
comparing the acquired said first host information with said second host information;
executing the following steps (A) through (C) when, in accordance with the result of said comparison, said first data processing environment is supported by said second host computer:
(A) sending to said storage subsystem a host group creation request for preparing a new host group corresponding to said second host computer, sending an input/output format information setting request based on OS information in said second host information to the storage subsystem, sending a volume ID of said first logical volume to the storage subsystem, and sending a port ID of a communication port to the storage subsystem, thereby, the controller of said storage subsystem adds a new group ID denoting said new host group to said storage region, and associates to the new group ID said setting-requested input/output format information, the volume ID of said first logical volume, and the port ID of said communication port;
(B) sending to said first host computer a disconnection request for disconnecting said first logical volume inside said storage subsystem, and, by said first host computer responding to the disconnection request, disconnecting said first logical volume from said first host computer;
(C) sending to said second host computer a connection request for connecting said first logical volume, and, thereby, said second host computer connecting to said first logical volume, and
executing the following steps (a) through (b) when, in accordance with the result of said comparison, said first data processing environment is not supported by said second host computer:
(a) sending a host group creation request for preparing a new host group corresponding to said second host computer to either said storage subsystem or said other storage subsystem, sending an input/output format information setting request based on OS information in said second host information to the transmission destination of said host group creation request, sending the volume ID of a second logical volume to be newly prepared in either said storage subsystem or said other storage subsystem to the transmission destination of said host group creation request, and sending the port ID of a communication port to the transmission destination of said host group creation request, thereby, either the controller of said storage subsystem or the controller of said other storage subsystem adds a new group ID denoting said new host group to said storage region, and associates to the new group ID said setting-requested input/output format information, the volume ID of said second logical volume, and the port ID of said communication port; and
(b) connecting said prepared second logical volume to said second host computer, causing said second host computer to create a file system for recognizing a data file written to said second logical volume, and causing said first host computer to read out all data inside said first logical volume and transfer the same to said second host computer, thereby, when said second host computer writes said transferred data to said second logical volume, and updates said created file system accordingly and all data inside said first logical volume is written to said second logical volume, the data inside said second logical volume can be recognized using said updated file system.

19. The method according to claim 18, wherein
said first host information comprises a first OS type information denoting the type of a first OS of said first host computer;
said second host information comprises a second OS type information denoting the type of a second OS of said second host computer; and
when said first data processing environment is supported by said second host computer, the second OS type denoted by said second OS type information is compatible with the first OS type denoted by said first OS type information.

20. The method according to claim 19, wherein
said first host information further comprises a first volume format information denoting a first volume format supported by said first OS;
said second host information further comprises a second volume format information denoting a second volume format supported by said second OS; and
when the second volume format denoted by said second volume format information supports the first volume format denoted by said first volume format information, even if the second OS type denoted by said second OS type information is not compatible with the first OS type denoted by said first OS type information, said first data processing environment is still supported by said second host computer.
